(19) United States
(12) Patent Application Publication
(10) Pub. No.: US 2008/0096490 A1
(43) Pub. Date: Apr. 24, 2008

(54) SEMICONDUCTOR INTEGRATED CIRCUIT FOR RF COMMUNICATIONS

(76) Inventors: Takao Okazaki, Hamura (JP); Kaoru Koyu, Ome (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/877,392

(22) Filed: Oct. 23, 2007

(30) Foreign Application Priority Data
Oct. 24, 2006 (JP) 2006-288356

(51) Int. Cl. H04B 1/40

(52) U.S. Cl. 455/76; 375/219

(57) ABSTRACT

An AFC-control D/A converter which controls a reference frequency oscillator is a voltage-potentiometer-type D/A converter containing three voltage followers. At least in the latter-stage voltage follower, an NMOS differential input circuit, a CMOS output circuit, and a bias circuit are supplied with an external power voltage. However, PMOS differential input circuit is supplied with an internal regulated power supply voltage generated by a reference voltage generator. Even if there is a shift in the pair nature of MP1 and MP2 of the differential PMOS, an increase of current of MP3 of a PMOS current source due to the increase of the external power voltage is suppressed. Also an input offset voltage of the differential PMOS does not increase, and a change of an AFC control analog output signal can be reduced.

### CLAIM OF PRIORITY

The Present application claims priority from Japanese application JP 2006-288356 filed on Oct. 24, 2006, the content of which is hereby incorporated by reference into this application.

### FIELD OF THE INVENTION

The present invention relates to a semiconductor integrated circuit for RF communications which performs a signal transfer bidirectionally with a digital interface and an LSI which contains an RF-reception-signal analog signal processing subunit and an RF-transmission-signal analog signal processing subunit and performs baseband digital signal processing. The present invention relates to art useful for reducing change of an AFC control analog output signal of an AFC-control D/A converter for controlling the oscillating frequency of a reference frequency oscillator, due to the change of the external power voltage, by converting the AFC control digital input signal supplied from the LSI into an AFC control analog output signal.

### BACKGROUND OF THE INVENTION

In the general PLL (Phase Locked Loop) circuit with a dividing ratio of only an integer, the frequency resolution of a locked loop is given by a reference frequency f_{REF}. Therefore, a precise frequency resolution requires a small reference frequency f_{REF}, leading to a narrow loop frequency band. The narrow loop frequency band corresponds to an unfavorably long switching time. Suppression of a phase noise of a voltage-controlled oscillator (VCO) in the PLL circuit is insufficient, and the PLL circuit tends to be influenced by noises from the outside of the PLL circuit.

According to Non Patent Document 1, a fractional synthesizer has been developed since it has the frequency resolution more precise than the reference frequency f_{REF}, In a fractional-N divider, a dividing ratio is periodically changed from N to N+1, and an average division ratio increases from N by the duty ratio of (N+1) dividing as a result. The overflow from an accumulator is used in order to modulate a momentary dividing ratio.

Thus, in the fractional-N PLL circuit, the dividing ratio N of the divider in the negative feedback loop of the PLL circuit is a rational number containing not only an integer but a fraction (decimal). Non Patent Document 2 describes that a fractional-N PLL circuit with sufficient bandwidth and resolution is employed for the transmitter/receiver of a GSM system in order to choose a desired channel and to catch a modulation. In this fractional-N PLL circuit, since a ΣΔ-modulator to which digital data is supplied controls a denominator by a divider, the oscillating frequency of a voltage-controlled oscillator is modulated around the center of the desired channel.

On the other hand, Non Patent Document 3 describes a voltage-potentiometer-type D/A converter. In this D/A converter, a reference voltage is supplied to first plural voltage dividing resistors connected in series, and two arbitrary connection nodes are chosen from plural connection nodes among the first plural voltage dividing resistors connected in series, by first plural switches controlled by upper bits. Two selected voltages are supplied to the first and the second voltage followers. One arbitrary connection node is chosen from plural connection nodes among second plural voltage dividing resistors which are connected in series between the outputs of the two voltage followers, by second plural switches controlled by lower bits. One selected voltage is supplied to a third voltage follower, and the D/A conversion output is created in terms of the output of the third voltage follower.

Non Patent Document 4 describes a rail-to-rail amplifier of the CMOS composition which possesses an NMOS differential input circuit, a PMOS differential input circuit, and a CMOS output circuit. By the person skilled in the art, the rail-to-rail amplifier is understood to be an amplifier in which the maximum allowable input is almost equal to the power supply voltage, and the maximum available output amplitude is almost equal to the power supply voltage as well. In Non Patent Document 4, in order to set constant the gain bandwidth product of the rail-to-rail amplifier, a stabilized internal power supply voltage Vint of about 1.2V is generated from an external power voltage Vext of 1.3V or more by a negative feedback voltage generation circuit, and supplied to a source of a PMOS constant current transistor of the PMOS differential input circuit. In addition, Non Patent Document 4 describes that the reason is to satisfy the cross point condition between the NMOS differential input circuit and the PMOS differential input circuit, where the condition is (gate-to-source voltage Vgsn of differential NMOS+drain-to-source voltage Vdsn of constant current NMOS=power supply voltage Vdd−gate-to-source voltage Vgsp of differential PMOS−drain-to-source voltage Vdsp of constant current PMOS).

[Non Patent Document 1] Brian Miller and Robert J. Conley; “A Multiple Modulator Fractional Divider”, IEEE TRANSACTIONS ON INSTRUMENTATION AND MEASUREMENT, Vol. 40, No. 3, JUNE 1991, PP. 578-583.

[Non Patent Document 2] E. Hegazi et al; “A 17 mW Transmitter and Frequency Synthesizer for 900 MHz GSM Fully Integrated in 0.35-μm CMOS”, 2002 Symposium on VLSI Circuits, Digest of Technical Papers, PP. 234-237.

[Non Patent Document 3] Peter Holloway; “A Timeless 16b Digital Potentiometer”, 1984 IEEE International Solid State Circuits Conference, DIGEST OF TECHNICAL PAPERS, PP. 66-67, 320-321.

[Non Patent Document 4] Giuseppe Ferri et al; “A Rail-to-Rail Constant-gm Low-Voltage CMOS Operational Tansconductance Amplifier”, IEEE JOURNAL OF SOLID-STATE CIRCUITS, Vol. 32, No. 10, OCTOBER 1997, PP. 1563-1567.

### SUMMARY OF THE INVENTION

The present inventors were engaged in development of an RF IC which supports communication of GSM system, in advance of the present invention.

GSM system (Global System for Mobile Communication) is a communication mode which performs GMSK (Gaussian Minimum Shift Keying) modulation in which only phase modulation is used, as one of TDMA system. TDMA is the abbreviation for Time Division Multiple Access. In the TDMA system, each time slot of plural time slots of a mobile phone terminal apparatus can be set as either of an idle state, receiving operation from a base station, and send operation to the base station. Other systems which can improve a communication data transfer rate as compared with the GSM system are also known. As one of the improvement systems, EDGE (Enhanced Data for GSM Evolution; Enhanced Data for GPRS) system which uses amplitude modulation as well as phase modulation also attracts attention these days. GPRS is the abbreviation for General Packet Radio Service.

In the fractional-N PLL circuit of the RF IC, based on the reference oscillating frequency f_{REF} of a reference frequency oscillator VCXO which generates a stable-and-accurate reference signal with a crystal oscillator and an automatic frequency control (AFC) signal from a baseband LSI, the oscillating frequency f_{TXVCO} of an RF-transmission voltage controlled oscillator TXVCO and the oscillating frequency f_{RFVCO} of an RF voltage controlled oscillator RFVCO of a frequency synthesizer used in a transmitter/receiver are generated. The RF IC corresponding to the latest GSM communication system is constituted so that it may support four frequency bands; GSM 850 MHz, GSM 900 MHz, DCS 1800 MHz, and PCS 1900 MHz. Therefore, the oscillating frequency f_{TXVCO} of the RF-transmission voltage controlled oscillator TXVCO and the oscillating frequency f_{RFVCO} of the RF voltage controlled oscillator RFVCO must support these four multifrequency bands. The reference oscillating frequency f_{REF} of the reference frequency oscillator VCXO of RF IC is a comparatively-low frequency of tens of MHz order. On the contrary, the oscillating frequency f_{TXVCO} of the RF-transmission voltage controlled oscillator TXVCO and the oscillating frequency f_{RFVCO} of the RF voltage controlled oscillator RFVCO corresponding to plural multifrequency bands are a comparatively-high frequency of several GHz order. Thus, as compared with the reference oscillating frequency f_{REF} of the reference frequency oscillator VCXO, the oscillating frequency f_{TXVCO} from the RF-transmission voltage controlled oscillator TXVCO and the oscillating frequency f_{RFVCO} of RF voltage controlled oscillator RFVCO are found to be much higher frequencies. Thus, the fractional-N PLL circuit of RF IC generates the reference oscillating frequency f_{TXVCO} of the RF-transmission voltage controlled oscillator TXVCO and the oscillating frequency f_{RFVCO} of RF voltage controlled oscillator RFVCO in several GHz order, by performing frequency multiplication of the reference oscillating frequency f_{REF} of the tens of MHz order of the reference frequency oscillator VCXO, by the frequency multiplication ratio which is the inverse number of a fractional N dividing ratio.

On the other hand, since an external power voltage of the standard value of 2.8 V with the range of fluctuation of 2.67 V (minimum) to 3.0 V (maximum) is supplied to RF IC, the reference oscillating frequency f_{REF} of the reference frequency oscillator VCXO must be kept constant, irrespective of the external power voltage fluctuation. For this reason, a fluctuating external power voltage is supplied to an on-chip voltage regulator, and an internal regulated power supply voltage maintained to a stable value of about 2.45 V will be generated by the on-chip voltage regulator and supplied to the reference frequency oscillator VCXO. If the internal regulated power supply voltage maintained to the stable value is supplied to the reference frequency oscillator VCXO, the reference oscillating frequency f_{REF} of the reference frequency oscillator VCXO does not change due to the external power voltage fluctuation, but stays in the stable reference oscillating frequency f_{REF} of tens of MHz order. Therefore, it is not necessary to supply the internal regulated power supply voltage produced by the on-chip voltage regulator to RF voltage controlled oscillator RFVCO and RF-transmission voltage controlled oscillator TXVCO in the fractional-N PLL circuit of RF IC. The oscillating frequency f_{TXVCO} of RF-transmission voltage controlled oscillator TXVCO and the oscillating frequency f_{RFVCO} of RF voltage controlled oscillator RFVCO can be still stably maintained by the fractional-N PLL circuit at the frequency multiplication ratio which is the inverse number of a fractional N dividing ratio. In this way, the fractional-N PLL circuit will contain RF voltage controlled oscillator RFVCO for generating the RF carrier signal which is used in the frequency down-conversion from an RF reception signal to a baseband reception signal in the receiving-system signal processing subunit of RF IC, and in the frequency up-conversion from a baseband transmitting signal to an intermediate frequency transmitting signal or an RF transmission signal in the transmission-system signal processing subunit of RF IC. When the oscillating frequency of RF voltage controlled oscillator RFVCO of this fractional-N PLL circuit is set up by the fractional dividing, finally the oscillating frequency of the RF-transmission voltage controlled oscillator TXVCO is set up.

On the other hand, transmitter/receivers, such as a mobile terminal device, generally contain an RF IC and a baseband LSI. The RF IC performs the modulation/demodulation, frequency up-conversion of a transmission signal, and frequency down-conversion of a reception signal. The baseband LSI converts a sending signal into a fundamental wave, an in-phase-component I-digital baseband transmitting signal and a quadrature-component Q-digital baseband transmitting signal. The baseband LSI also restores received data from the I-digital baseband reception signal and the Q-digital baseband reception signal. Thus, the signal processing of RF IC is mainly analog signal processing, and the signal processing of the baseband LSI is mainly digital signal processing. An A/D converter to convert an analog signal into a digital signal and a D/A converter to convert a digital signal into an analog signal are required for signal transfer between RF IC and the baseband LSI. However, since these kinds of A/D and D/A converters were arranged conventionally in the baseband LSI, the signal transfer among RF IC and the baseband LSI was carried out in analog form.

On the other hand, the baseband LSI which performs digital signal processing mainly has changed to integrate transistors in which minuteness making is much more advanced than in RF IC by progress of process technology, and the power supply voltage has a trend to fall to 1.8 V or less. Therefore, it is difficult to arrange in the baseband LSI an A/D converter and a D/A converter which require operating voltage higher than 2 V. In such a situation, development of RF IC and a baseband LSI with a digital interface, in which the signal transfer among them is carried out in digital form, has been furthered, by arranging the A/D converter and D/A converter required between them in RF IC.

FIG. 1 illustrates the entire configuration of a mobile terminal device which carries RF IC and a baseband LSI with the digital interface and has been examined by the present inventors in advance of the present invention. Moreover, FIG. 1 also illustrates the entire configuration of a mobile terminal device according to one embodiment of the present invention. Although the mobile terminal device is the mobile phone terminal device in the present description, alternatively the mobile terminal device may be the mobile communication device for a notebook-size personal computer or a PDA (Personal Digital Assist) device. In the mobile terminal device illustrated in FIG. 1, A/D converters 303 and 304 and D/A converters 307, 308, and 315 are arranged in an RF analog signal processing integrated circuit (RF_IC) 300. Namely, the A/D converters 303 and 304 convert into the digital baseband signals RxDBI and RxDBQ the analog baseband signals RxABI and RxABQ which are the output of an RF-reception-signal analog signal processing subunit (RX SPU) 301 in an RF analog signal processing integrated circuit (RF_IC) 300, and supply the digital baseband signals RxDBI and RxDBQ to a baseband signal processing LSI (BB_LSI) 400. Moreover, D/A converters 307 and 308 convert the quadrature components TxDBI and TxDBQ of the output of the baseband signal processing LSI (BB_LSI) 400 into analog baseband transmitting signals TxABI and TxABQ, and supply them to an RF-transmission-signal analog signal processing subunit (TX SPU) 302 in the RF analog signal processing integrated circuit (RF_IC) 300.

Furthermore, an AFC-control D/A converter (AFCDAC) 315 converts the AFC control digital signal of the output of the baseband processor core 401, obtained in the digital signal path L3 of an RF digital interface 402 of the baseband signal processing LSI 400, into an AFC control analog signal. Then the AFC-control D/A converter (AFCDAC) 315 supplies the AFC control analog signal to the system reference clock oscillator (VCXO) 314.

Since the other constitutions and operations of the mobile terminal device illustrated in FIG. 1 will be explained in detail in the following “Detailed Description of the Invention”, the explanation thereof is omitted here.

FIG. 2 is a circuit diagram illustrating the constitution of the AFC-control D/A converter (AFCDAC) 315 arranged in the RF analog signal processing integrated circuit (RF_IC) 300 of the mobile terminal device illustrated in FIG. 1.

Although various kinds of D/A converters are known, the AFC-control D/A converter (AFCDAC) 315 employs a voltage-potentiometer-type D/A converter described in Non Patent Document 3. This is because the AFC control digital signal is low speed data of several 10 kHz to several 100 kHz, and because a high-precision analog-converted output in 8 to 16 bits is obtained with a low power by the voltage-potentiometer-type D/A converter.

In the AFC-control D/A converter (AFCDAC) 315, the reference voltage V_{REF} of about 2.45V is supplied to one end of first plural series-connected voltage dividing resistors (R . . . R) of a first variable voltage divider (VDIV1). Two arbitrary connection nodes from plural connection nodes (N15, N14, N13 . . . N00) among the first plural series-connected voltage dividing resistors (R . . . R) of the first variable voltage divider (VDIV1) is chosen by plural switches (SWH15, SWH14 . . . SWH00) which are controlled by the upper 4 bits (D12 . . . D09). As a result, the rough selection of analog voltage is performed by the upper 4 bits (D12 . . . D09). The two analog rough selection voltages are supplied to a first and a second voltage follower (AMP1, AMP2) of a first buffer (Buff1). One arbitrary connection node from plural connection nodes (N511, N510 . . . ND00) among second plural voltage dividing resistors (r/2, r . . . r, r/2) connected in series to a second variable voltage divider (VDIV2) between the outputs of the two voltage followers (AMP1, AMP2) is chosen by second plural switches (SWL511, SWL510 . . . SWL00) which are controlled by the lower 9 bits (DO8 . . . D00). As a result, the fine selection of analog voltage is performed by the lower 9 bits (D08 . . . D00). One analog fine selection voltage is supplied to a third voltage follower (AMP3) of a second buffer (Buff2), and a D/A conversion output is created from the output of the third voltage follower (AMP3). The output of the third voltage follower (AMP3) is supplied to a low pass filter (LPF) which is comprised of a resistance R1 and a capacity C1. Thereby, an AFC control analog signal (V_{TUNE}), which controls the oscillating frequency of a system reference clock signal SysCLk of a system reference clock oscillator (VCXO) 314, is created. The AFC control analog signal (V_{TUNE}) from the low pass filter (LPF) is supplied to a variable capacitance element (VC) of the system reference clock oscillator (VCXO) 314 through a resistance R2 and a capacity C2. The oscillating frequency of the system reference clock signal SysCLk of the system reference clock oscillator (VCXO) 314 is controlled by change of the capacity value of the variable capacitance element (VC). In addition, the external power voltage of the standard value of 2.8 V with the range of fluctuation of 2.67 V (minimum) to 3.0 V (maximum), which is supplied to the RF analog signal processing integrated circuit (RF_IC) 300, is supplied to a band-gap reference circuit (BGR) of a reference voltage generator (RVG). Thereby, a band-gap reference voltage Vref of about 1.23 V is created from the band-gap reference circuit (BGR). The internal regulated power supply voltage (V_{REF}) maintained to the stable value of about 2.45 V is created from the reference voltage Vref of about 1.23 V, and supplied to one end of the first plural series-connected voltage dividing resistors (R . . . R) of the first variable voltage divider (VDIV1). In addition, the upper 4 bits (D12 . . . D09) and the lower 9 bits (D08 . . . D00) of 13 bits are supplied to a 4-bit decoder (4 bit Dec) and a 9-bit decoder (9 bit Dec), respectively. Turning on and off of the plural switches (SWH16, SWH15 . . . SWH00) is controlled by the 16-bit output of the 4-bit decoder (4 bit Dec). Turning on and off of the second plural switches (SWL511, SWL510 . . . SWL00) is controlled by the 512-bit output of the 9-bit decoder (9 bit Dec). Moreover, the external power voltage Vdd_ext is supplied to three voltage followers (AMP1, AMP2, AMP3).

On the other hand, in the mobile terminal device illustrated in FIG. 1, it is necessary to change the oscillating frequency of the system reference clock signal SysCLk of the system reference clock oscillator (VCXO) 314 from the center frequency of 26 MHz in the change width of 110 ppm (0.011%). That is, the oscillating frequency of the system reference clock signal SysCLk must cover the range from 25.99857 MHz which is 55 ppm lower than 26 MHz to 26.00143 MHz which is 55 ppm higher than 26 MHz. It is necessary to keep the AFC control analog signal (V_{TUNE}) supplied to the variable capacitance element (VC) of the system reference clock oscillator (VCXO) 314 to 0.1V for obtaining the high frequency of 26.00143 MHz. While it is necessary to keep the AFC control analog signal (V_{TUNE}) supplied to the variable capacitance element (VC) of the system reference clock oscillator (VCXO) 314 to 2.4V for obtaining the low frequency of 25.99857 MHz.

Therefore, it is necessary to change the level of the AFC control analog signal (V_{TUNE}), converted from the AFC-control D/A converter (AFCDAC) 315 illustrated in FIG. 2, from 0.1V to 2.4V by changing the 13-bit digital input signal. However, the minimum of the external power voltage (Vdd_ext) supplied to three voltage followers (AMP1, AMP2, AMP3) of the AFC-control D/A converter (AFCDAC) 315 is 2.67V. Thus, the minimum of 2.67 V of the external power voltage (Vdd_ext) and the maximum level of 2.4 V of the AFC control analog signal (V_{TUNE}) are close. Therefore, three voltage followers (AMP1, AMP2, AMP3) needs to be constituted by a rail-to-rail amplifier, described in Non Patent Document 4, in which the allowable maximum input is almost equal to the power supply voltage and the available output amplitude is also almost equal to the power supply voltage. Since the maximum and the minimum of the analog rough selection voltage which are supplied to two voltage followers (AMP1, AMP2) of the preceding stage are 2.45 V and zero volt, respectively, two voltage followers (AMP1, AMP2) of the preceding stage needs to be comprised of a rail-to-rail amplifier. Since the maximum and the minimum of the analog fine selection voltage which are supplied to the voltage follower (AMP3) of the latter stage are about 2.45 V and zero volt, respectively, the voltage follower (AMP3) of the latter stage also needs to be comprised of a rail-to-rail amplifier.

FIG. 3 is a circuit diagram illustrating the constitution of a CMOS rail-to-rail amplifier which constitutes three voltage followers (AMP1, AMP2, AMP3) of the AFC-control D/A converter (AFCDAC) 315 illustrated in FIG. 2. The CMOS rail-to-rail amplifier illustrated in FIG. 3 is comprised of an NMOS differential input circuit (NMOS_DA), a PMOS differential input circuit (PMOS_DA), and a CMOS output circuit (OUT_CKT), plus a bias circuit (BIAS_CKT), the former three being almost same as one described in Non Patent Document 4. The CMOS rail-to-rail amplifier is supplied with the external power voltage (Vdd_ext) of the standard value of 2.8 V with the range of fluctuation of 2.67 V (minimum) to 3.0 V (maximum) and a ground potential (GND). A non-inverted input terminal (Vinp) of the CMOS rail-to-rail amplifier is connected to the gate of MN1 of NMOS of the NMOS differential input circuit (NMOS_DA), and to the gate of MP1 of PMOS of the PMOS differential input circuit (PMOS_DA). An inverted input terminal (Vinn) of the CMOS rail-to-rail amplifier is connected to an output terminal (Vout), to the gate of MN2 of NMOS of the NMOS differential input circuit (NMOS_DA), and to the gate of MP2 of PMOS of the PMOS differential input circuit (PMOS_DA). The sources of MN1 and MN2 of the NMOS of the NMOS differential input circuit (NMOS_DA) are connected to the drain of MN3 of NMOS of the NMOS constant current source transistor. The sources of MP1 and MP2 of PMOS of the PMOS differential input circuit (PMOS_DA) are connected to the drain of MP3 of PMOS of the PMOS constant current source transistor. The constant current of MN3 of NMOS of the NMOS constant current source transistor of the NMOS differential input circuit (NMOS_DA), and the constant current of MP3 of PMOS of the PMOS constant current source transistor of the PMOS differential input circuit (PMOS_DA) are respectively set up by the current of MN10 of NMOS and the current of MP8 of PMOS, both belonging to the bias circuit (BIAS_CKT). In addition, these currents are set up by the current of a constant current source Ibias connected to the external power voltage (Vdd_ext). The drains of MN1 and MN2 of NMOS of the NMOS differential input circuit (NMOS_DA) are connected to the drains of MP4 and MP5 of PMOS as a load element, and the drains of MP1 and MP2 of PMOS of the PMOS differential input circuit (PMOS_DA) are connected to the drains of MN4 and MN5 of NMOS as a load element. The drain output signals of MN1 and MN2 of NMOS of the NMOS differential input circuit (NMOS_DA) are supplied to the gates of MP6 and MP7 of PMOS of the CMOS output circuit (OUT_CKT), and the drain output signals of MP1 and MP2 of PMOS of the PMOS differential input circuit (PMOS_DA) are supplied to the gates of MP6 and MP7 of PMOS of the CMOS output circuit (OUT_CKT) through MN6 and MN7 of NMOS. The drains of MP6 and MP7 of PMOS of the CMOS output circuit (OUT_CKT) are connected to the drains of MN8 and MN9 of the NMOS current mirror which is an active load. In addition, the series connection of a negative feedback resistance Rf and a negative feedback capacity Cf for phase compensation is connected between the drain and the gate of MP7 of PMOS.

From the description about the cross point conditions of Non Patent Document 4, the following can be understood, namely, if the voltage level of both the inputs of the non-inverted input terminal (Vinp) and the inverted input terminal (Vinn) of the NMOS differential input circuit (NMOS_DA) of FIG. 3 deceases less than the value of “(the gate-to-source voltage Vgsn of MN1 and MN2 of the differential NMOS)+(the drain-to-source voltage Vdsn of MN3 of the constant current NMOS)”, operation of the NMOS differential input circuit (NMOS_DA) of FIG. 3 becomes impossible. Similarly, the following can be understood, namely, if the voltage level of both the inputs of the non-inverted input terminal (Vinp) and the inverted input terminal (Vinn) of the PMOS differential input circuit (PMOS_DA) of FIG. 3 increases higher than the value of “(the external power voltage (Vdd_ext))−(the gate-to-source voltage Vgsp of MP1 and MP2 of the differential PMOS)−(the drain-to-source voltage Vdsp of MP3 of the constant current PMOS)”, operation of the PMOS differential input circuit (PMOS_DA) of FIG. 3 becomes impossible.

Therefore, the NMOS differential pair MN1 and MN2 of the NMOS differential input circuit (NMOS_DA) pulls up the voltage of the output terminal (Vout) to the direction of the external power voltage (Vdd_ext), mainly from near the intermediate level of the non-inverted input terminal (Vinp) and the inverted input terminal (Vinn), due to the high degree of conduction of MP7 of PMOS of the CMOS output circuit (OUT_CKT), in response to a high level of the differential input signal. For example, when the voltages of the inverted input terminal (Vinn) and the output terminal (Vout) are at a low level and a comparatively-high level of the analog input voltage is supplied to the non-inverted input terminal (Vinp), MN1 and MN2 become in an ON state and an OFF state, respectively, the voltage of the output terminal (Vout) can be pulled up to the direction of the external power voltage (Vdd_ext), due to the high degree of conduction of MP7 of PMOS of the CMOS output circuit (OUT_CKT). On the contrary, the PMOS differential pair MP1 and MP2 of the PMOS differential input circuit (PMOS_DA) pulls down the voltage of the output terminal (Vout) to the direction of the ground potential (GND), mainly from near the intermediate level of the non-inverted input terminal (Vinp) and the inverted input terminal (Vinn), due to the high degree of conduction of MN9 of NMOS of the CMOS output circuit (OUT_CKT), in response to a low level of the differential input signal. For example, when the voltages of the inverted input terminal (Vinn) and the output terminal (Vout) are at a high level and a comparatively-low level of the analog input voltage is supplied to the non-inverted input terminal (Vinp), MP1 and MP2 become in an ON state and an OFF state, respectively, the voltage of the output terminal (Vout) can be pulled down to the direction of the ground potential (GND), due to the high degree of conduction of MN9 of NMOS of the CMOS output circuit (OUT_CKT). In addition, when the voltages of both the inputs of the non-inverted input terminal (Vinp) and the inverted input terminal (Vinn) are near an intermediate level, the NMOS differential input circuit (NMOS_DA) and the PMOS differential input circuit (PMOS_DA) of FIG. 3 operate in cooperation, like a voltage follower in which the voltage level of the inverted input terminal (Vinn) and the output terminal (Vout) are forced to follow the voltage level of the non-inverted input terminal (Vinp).

In the voltage follower operation by the voltage followers (AMP1, AMP2, AMP3) illustrated in FIG. 3, it is assumed that 100% pair nature in the electrical property of NMOS differential pair MN1 and MN2 of the NMOS differential input circuit (NMOS_DA) is attained, and that 100% pair nature in the electrical property of PMOS differential pair MP1 and MP2 of the PMOS differential input circuit (PMOS_DA) is attained. In this case, the difference input offset voltage of the NMOS differential input circuit (NMOS_DA) and the PMOS differential input circuit (PMOS_DA) becomes zero volt. However, when the pair nature deviates in error from 100%, the difference input offset voltage increases from zero volt to an error which cannot be ignored, as well known.

The difference input offset voltages Vinoffset (N) and Vinoffset (P) in the respective voltage follower operation of the NMOS differential input circuit (NMOS_DA) and the PMOS differential input circuit (PMOS_DA) of FIG. 3 can be calculated as follows. In the calculation, the threshold voltage and the conductance of the NMOS differential pair MN1 and MN2 of the NMOS differential input circuit (NMOS_DA) are respectively written as Vthn1, Vthn2, βn1, and βn2, and the threshold voltage and the conductance of the PMOS differential pair MP1 and MP2 of the PMOS differential input circuit (PMOS_DA) are respectively written as Vthp1, Vthp2, βp1, and βp2. Moreover, the difference input offset voltage is calculated assuming the state where the current of the drain-to-source path of the NMOS differential pair MN1 and MN2 of the NMOS differential input circuit (NMOS_DA) is balanced with the equal current Io, and the current of the drain-to-source path of the PMOS differential pair MP1 and MP2 of the PMOS differential input circuit (PMOS_DA) is balanced with the equal current Io. Moreover, the conductance β of the channel of an MOS transistor is a constant proportional to the value of (W (channel width)/L (channel length)), as known well.

Vinoffset(N)=−Vthn1+Vthn2−(2Io/βn1)^{1/2}+(2Io/βn2)^{1/2} (Eq. 1)

Vinoffset(P)=|Vthp1|−|Vthp2|+(2Io/βp1)^{1/2}−(2Io/βp2)^{1/2} (Eq. 2)

Therefore, when 100% pair nature of the electrical property of the differential pair MOS is attained from the above two equations, the first term and the second term are canceled and the third term and the fourth term are canceled in either of the two equations, and the difference input offset voltages Vinoffset (N) and Vinoffset (P) become zero volt. However, if the error from 100% of the pair nature of the electrical property of the differential pair MOS increases, the difference input offset voltages Vinoffset (N) and Vinoffset (P) do not become zero volt, but increase with the error of the pair nature of the differential pair MOS.

Moreover, from the difference input offset voltages Vinoffset (N) and Vinoffset (P) in each of the voltage follower operation of the NMOS differential input circuit (NMOS_DA) and the PMOS differential input circuit (PMOS_DA), the relation of the output voltage Vout and the non-inverted input terminal voltage Vinp in the voltage follower operation of the voltage followers (AMP1, AMP2, AMP3) illustrated in FIG. 3 becomes as follows. Here, Vout (N) indicates the effect by the difference input offset voltage Vinoffset (N) of the NMOS differential input circuit (NMOS_DA), and Vout (P) indicates the effect by the difference input offset voltage Vinoffset (P) of the PMOS differential input circuit (PMOS_DA).

Vout(N)=Vinp+Vinoffset(N) (Eq. 3)

Vout(P)=Vinp+Vinoffset(P) (Eq. 4)

As explained above, if the error from 100% of the pair nature of the electrical property of the differential pair MOS increases in the voltage followers (AMP1, AMP2, AMP3) illustrated in FIG. 3, the difference input offset voltages Vinoffset (N) and Vinoffset (P) increase to an unignorable steady-state error from a zero volt. As a result, the steady-state error of the AFC control analog output signal (V_{TUNE}) of the AFC-control D/A converter (AFCDAC) 315 illustrated in FIG. 2 eventually arises.

Moreover, the examination of the present inventors has found the fact that the error of the pair nature of the electrical property of the differential pair MOS not only turns into a steady-state error of the AFC control analog output signal (V_{TUNE}) of the AFC-control D/A converter (AFCDAC) 315 of FIG. 2, but becomes a cause of change of the AFC control analog output signal (V_{TUNE}) of the AFC-control D/A converter (AFCDAC) 315 due to the change of the external power voltage (Vdd_ext).

FIG. 4 illustrates a simulation result indicating change ΔVout of the AFC control analog output signal (V_{TUNE}) of the AFC-control D/A converter (AFCDAC) 315 illustrated in FIG. 2, due to the change of the external power voltage (Vdd_ext) when the 100% pair nature of the electrical property of the differential pair MOS is attained. Taking into consideration that the external power voltage (Vdd_ext) has the standard value of 2.8 V with the range of fluctuation of 2.67 V (minimum) to 3.0 V (maximum), FIG. 4 illustrates the properties when the external power voltage (Vdd_ext) is 2.8 V+0.2 V=3.0 V, and of 2.8V−0.2V=2.6V. The horizontal axis of FIG. 4 is a digital code of the 13-bit AFC control digital input signal supplied to the AFC-control D/A converter (AFCDAC) 315 of FIG. 2, where the digital code changes from “4000” to “8000.” The AFC-control D/A converter (AFCDAC) 315 of FIG. 2 is designed such that, when the AFC control digital input signal of digital code “0000” is supplied, the AFC control analog output signal (V_{TUNE}) of zero volt is outputted, and when the AFC control digital input signal of digital code “8192” is supplied, the AFC control analog output signal (V_{TUNE}) of 2.4V is outputted. The vertical axis of FIG. 4 illustrates the change ΔVout of the AFC control analog output signal (V_{TUNE}) of the AFC-control D/A converter (AFCDAC) 315. It can be seen from FIG. 4 that, when the 100% pair nature of the electrical property of the differential pair MOS is attained, the change ΔVout of the AFC control analog output signal (V_{TUNE}) of the AFC-control D/A converter (AFCDAC) 315 due to the change from 2.6V to 3.0V in the external power voltage (Vdd_ext) is suppressed to a very small level of from about −1 mV to about +1 mV.

FIG. 5 illustrates a simulation result indicating change ΔVout of the AFC control analog output signal (V_{TUNE}) of the AFC-control D/A converter (AFCDAC) 315 illustrated in FIG. 2 due to the change of the external power voltage (Vdd_ext), for the case of 10% shift in the pair nature of the electrical property of the NMOS differential pair MN1 and MN2 of the NMOS differential input circuit (NMOS_DA) of FIG. 3. The digital code changes in a wide range from “0000” to “8000.” In addition, the present case assumes that the 100% pair nature of the electrical property of the PMOS differential pair MP1 and MP2 of the PMOS differential input circuit (PMOS_DA) of FIG. 3 is attained and that only the channel width of the NMOS differential pair MN1 and MN2 of the NMOS differential input circuit (NMOS_DA) is 0.9:1.0 with 10% shift. It can be seen from FIG. 5 that, when the pair nature of the electrical property of the NMOS differential pair MN1 and MN2 of the NMOS differential input circuit (NMOS_DA) shifts 10%, the change ΔVout of the AFC control analog output signal (V_{TUNE}) of the AFC-control D/A converter (AFCDAC) 315, due to the change of the external power voltage (Vdd_ext) from 2.6V to 3.0V, is a level of about −3.5 mV to about +3.5 mV.

FIG. 6 illustrates a simulation result indicating change ΔVout of the AFC control analog output signal (V_{TUNE}) of the AFC-control D/A converter (AFCDAC) 315 illustrated in FIG. 2, due to the change of the external power voltage (Vdd_ext), for the case of 10% shift in the pair nature of the electrical property of the PMOS differential pair MP1 and MP2 of the PMOS differential input circuit (PMOS_DA) of FIG. 3. The digital code changes in a wide range from “0000” to “8000.” In addition, the present case assumes that the 100% pair nature of the electrical property of the NMOS differential pair MN1 and MN2 of the NMOS differential input circuit (NMOS_DA) of FIG. 3 is attained and that only the channel width of the PMOS differential pair MP1 and MP2 of the PMOS differential input circuit (PMOS_DA) is 1.0:0.9 with 10% shift. From FIG. 6, the following can be seen, that is, when the pair nature of the electrical property of the PMOS differential pair MP1 and MP2 of the PMOS differential input circuit (PMOS_DA) shifts 10%, the change ΔVout of the AFC control analog output signal (V_{TUNE}) of the AFC-control D/A converter (AFCDAC) 315, due to the change of the external power voltage (Vdd_ext) from 2.6V of to 3.0V, is a level of about −3.5 mV to about +3.5 mV.

FIG. 7 illustrates a simulation result indicating change ΔVout of the AFC control analog output signal (V_{TUNE}) of the AFC-control D/A converter 315 illustrated in FIG. 2, due to the change of the external power voltage (Vdd_ext), for the case where the pair nature of the electrical property of the NMOS differential pair of the NMOS differential input circuit (NMOS_DA) of FIG. 3 shifts 10% and, in addition, the pair nature of the electrical property of the PMOS differential pair of the PMOS differential input circuit (PMOS_DA) shifts 10%. The digital code changes in a range from “0000” to “8000.” In addition, the present case assumes that the channel width of the NMOS differential pair MN1 and MN2 of the NMOS differential input circuit (NMOS_DA) is 0.9:1.0 with 10% shift, and that the channel width of the PMOS differential pair MP1 and MP2 of the PMOS differential input circuit (PMOS_DA) is 1.0:0.9 with 10% shift. It can be seen from FIG. 7 that, in such a case, the change ΔVout of the AFC control analog output signal (V_{TUNE}) of the AFC-control D/A converter (AFCDAC) 315, due to the change of the external power voltage (Vdd_ext) from 2.6V to 3.0V, is a level of about −2.0 mV to about +2.0 mV.

FIG. 8 illustrates a simulation result indicating change ΔVout of the AFC control analog output signal (V_{TUNE}) of the AFC-control D/A converter 315 illustrated in FIG. 2, due to the change of the external power voltage (Vdd_ext), for the case where the pair nature of the electrical property of the PMOS differential pair of the PMOS differential input circuit (PMOS_DA) shifts 10% while the pair nature of the electrical property of the NMOS differential pair of the NMOS differential input circuit (NMOS_DA) of FIG. 3 shifts 10%. The digital code changes in a wide range from “0000” to “8000.” In addition, the present case assumes that the channel width of the NMOS differential pair MN1 and MN2 of the NMOS differential input circuit (NMOS_DA) is 0.9:1.0 with 10% shift, as in FIG. 7, and that the channel width of the PMOS differential pair MP1 and MP2 of the PMOS differential input circuit (PMOS_DA) is 0.9:1.0 with 10% shift, contrary to FIG. 7. It can be seen from FIG. 8 that, in such a case, the change ΔVout of the AFC control analog output signal (V_{TUNE}) of the AFC-control D/A converter (AFCDAC) 315, due to the change of the external power voltage (Vdd_ext) from 2.6V to 3.0V, is a very large level of about −6.0 mV to about +6.0 mV.

FIG. 9 shows the experimental result illustrating a measured change ΔVout of the AFC control analog output signal (V_{TUNE}). In the experiment, a semiconductor chip including the AFC-control D/A converter (AFCDAC) 315 illustrated in FIG. 2 has been actually manufactured by way of trial. The digital code changes in a wide range from “0000” to “8000.” Actually the following is confirmed that the change ΔVout of the AFC control analog output signal (V_{TUNE}) of the AFC-control D/A converter (AFCDAC) 315, due to the change of the external power voltage (Vdd_ext) from 2.6V to 3.0V, is a very large level of about −3.0 mV to about +3.0 mV.

Moreover, it can be seen from FIG. 5 to FIG. 9 that the level of change ΔVout of the AFC control analog output signal (V_{TUNE}) of the AFC-control D/A converter (AFCDAC) 315, due to the change of the external power voltage (Vdd_ext), changes also depending on the digital code of the AFC control digital input signal supplied to the D/A converter 315.

In this way, the examination of the present inventors has clarified the emergence of an unsteady error. That is, the level of change ΔVout of the AFC control analog output signal (V_{TUNE}) changes also depending on the digital code of the AFC control digital input signal, the change ΔVout being due to the shift of the pair nature of the electrical property of the NMOS differential pair in the NMOS differential input circuit NMOS_DA or of the PMOS differential pair in the PMOS differential input circuit PMOS_DA, each serving as the voltage follower of FIG. 3.

On the other hand, as mentioned above, in the mobile terminal device illustrated in FIG. 1, it is necessary to change the oscillating frequency of the system reference clock signal SysCLk of the system reference clock oscillator (VCXO) 314 from the center frequency of 26 MHz with the change width of 110 ppm (0.011%), by changing the AFC control analog signal (V_{TUNE}) from 0.1 V to 2.4V. Therefore, the control sensitivity Kv, which is the change of the oscillating frequency of the system reference clock signal SysCLk due to the change of the AFC control analog signal (V_{TUNE}) of the system reference clock oscillator (VCXO) 314, can be calculated as follows.

$$\begin{matrix}K v = 110 ppm / ( 2.4 V - 0.1 V ) \\ = 110 ppm / 2.3 V \approx 0.048 ppm / mV \approx 0.05 ppm / mV\end{matrix}$$

On the other hand, according to the standard of a GSM (Global System for Mobile Communication) mode, in order to suppress the level of the disturbance signal included in a sending signal, it is required that the error of the reference frequency of the system reference clock signal between a mobile phone terminal apparatus and a base station should be reduced to 0.1 ppm or less. The examination by the present inventors has clarified the following design constraint that the change or the error of the AFC control analog output signal (V_{TUNE}) of the AFC-control D/A converter 315 should be suppressed to 2.0 mV or less, in order to satisfy the limit that the error of the reference frequency of the system reference clock signal according to the GSM standard should be 0.1 ppm or less, and the conditions that the control sensitivity Kv of the system reference clock oscillator 314 is about 0.05 ppm/mV. However, the following has been also clarified by the examination of the present inventors. That is, the properties of the change ΔVout of the AFC control analog output signal (V_{TUNE}) of the AFC-control D/A converter (AFCDAC) 315 illustrated in FIG. 5 through FIG. 9 do not satisfy the design constraint that the change or the error of the AFC control analog output signal (V_{TUNE}) of the AFC-control D/A converter (AFCDAC) 315 should be 2.0 mV or less.

Before solving this technical problem, the present inventors have clarified the generation mechanism of the change ΔVout of the AFC control analog output signal (V_{TUNE}) of the AFC-control D/A converter (AFCDAC) 315 illustrated in FIG. 5 through FIG. 9. The change of the external power voltage (Vdd_ext) serves as a common mode signal to the NMOS differential pair MN1 and MN2 of the NMOS differential input circuit (NMOS_DA), and also to the PMOS differential pair MP1 and MP2 of the PMOS differential input circuit (PMOS_DA). Generally, it is believed by the person skilled in the art that the differential amplifier circuit possesses a high common-mode signal rejection ratio (CMRR) and is un-responsive to the common mode signal applied thereto.

However, these general principles do not hold in the voltage followers (AMP1, AMP2, AMP3) illustrated in FIG. 3. First, the constant current of MN3 of NMOS of the NMOS constant current source transistor of the NMOS differential input circuit (NMOS_DA) and the constant current of MP3 of PMOS of the PMOS constant current source transistor of the PMOS differential input circuit (PMOS_DA) are set up by the constant current of the constant current source Ibias connected to the external power voltage (Vdd_ext) in the bias circuit (BIAS_CKT).

However, since the change of the external power voltage (Vdd_ext) is directly supplied to the source of MP3 of PMOS of the PMOS constant current source transistor of the PMOS differential input circuit (PMOS_DA), the source-to-drain voltage of MP3 is changed. Therefore, increase of the external power voltage (Vdd_ext) will increase the source-to-drain voltage of MP3. When MP3 has ideal saturation characteristics, even if the source-to-drain voltage increases, the constant current of MP3 of PMOS of the PMOS constant current source transistor does not increase. However, since MP3 does not have ideal saturation characteristics in practice, when the source-to-drain voltage increases, the current of MP3 of PMOS of the PMOS constant current source transistor increases. At this time, when there is shifting in the pair nature of the electrical property of the PMOS differential pair MP1 and MP2 of the PMOS differential input circuit (PMOS_DA), the difference between the third term and the fourth term of Eq. 2, which indicates the input-offset-voltage Vinoffset (P), increases by increase of the current of MP3 of PMOS. If the input-offset-voltage Vinoffset (P) increases, according to Eq. 4, the change ΔVout in the AFC control analog output signal (V_{TUNE}) of the AFC-control D/A converter (AFCDAC) 315 will emerge due to the increase of the current of MP3 by increase of the external power voltage (Vdd_ext).

On the other hand, since the source of MN3 of NMOS of the NMOS constant current source transistor of the NMOS differential input circuit (NMOS_DA) is connected to the ground voltage (GND), the voltage of the source of MN3 is stabilized mostly. The drain of MN3 is connected to the source of the NMOS differential pair MN1 and MN2 of the NMOS differential input circuit (NMOS_DA), and the voltage of the gates of the NMOS differential pair MN1 and MN2 is stably maintained to the level of the analog input signal by the voltage follower operation. Therefore, even if the external power voltage (Vdd_ext) increases, the source-to-drain voltage of MN3 does not increase. Therefore, even if MN3 does not have an ideal saturation property, the source-to-drain voltage does not increase and the current of MN3 of NMOS of the NMOS constant current source transistor does not increase. At this time, even if there is shifting in the pair nature of the electrical property of the NMOS differential pair MN1 and MN2 of the NMOS differential input circuit (NMOS_DA), since there is no increase of the current of MN3 of NMOS, the difference between the third term and the fourth term in Eq. 1, which indicates the input-offset-voltage Vinoffset (N), becomes almost constant. Since the input-offset-voltage Vinoffset (N) does not increase, the current of MN3 does not increase by increase of the external power voltage (Vdd_ext), according to Eq. 3. Consequently, the change ΔVout does not emerge in the AFC control analog output signal (V_{TUNE}) of the AFC-control D/A converter (AFCDAC) 315.

As the result of clarification of the mechanism by the present inventors as described above, the following fact is made clear. That is, to the change of the external power voltage (Vdd_ext), there is little change of the current value of MN3 of NMOS of the NMOS constant current source transistor of the NMOS differential input circuit (NMOS_DA), on the contrary there is large change of the current value of MP3 of PMOS of the PMOS constant current source transistor of the PMOS differential input circuit (PMOS_DA). Consequently, the current value of MP3 of PMOS of the PMOS constant current source transistor of the PMOS differential input circuit (PMOS_DA) increases by the increase of the external power voltage (Vdd_ext). At this time, when there is shifting in the pair nature of the electrical property of the PMOS differential pair MP1 and MP2 of the PMOS differential input circuit (PMOS_DA), the input offset voltage Vinoffset (P) of the PMOS differential input circuit (PMOS_DA) increases, and finally, a large change ΔVout will appear in the AFC control analog output signal (V_{TUNE}) of the AFC-control D/A converter (AFCDAC) 315.

Furthermore, the input offset voltage Vinoffset (P) of the PMOS differential input circuit (PMOS_DA) increases by the increase of the external power voltage (Vdd_ext). Thereby, the current of the drain-to-source path of the PMOS differential pair MP1 and MP2 of the PMOS differential input circuit (PMOS_DA) maintains the balance in equal current Io. However, the increase of the input-offset-voltage Vinoffset (P) of the PMOS differential input circuit (PMOS_DA) causes change of the output voltage Vout. The change of the output voltage Vout brings about the unbalance of the difference input voltage of the NMOS differential pair MN1 and MN2 of the NMOS differential input circuit (NMOS_DA), however, the NMOS differential pair MN1 and MN2 tries to maintain balance, by canceling the unbalance of the difference input voltage. Therefore, the operation by the PMOS differential pair MP1 and MP2 of the PMOS differential input circuit (PMOS_DA) and the operation by the NMOS differential pair MN1 and MN2 of the NMOS differential input circuit (NMOS_DA) become conflicting operation mutually. Consequently, as shown in FIG. 5 through FIG. 9, the level of change ΔVout of the AFC control analog output signal (V_{TUNE}) of the AFC-control D/A converter (AFCDAC) 315 due to the change of the external power voltage (Vdd_ext), is inferred to exhibit such complicated behavior that it changes even with the digital codes of the AFC control digital input signal supplied to the D/A converter 315.

In addition, by devising the layout of the CMOS device element of two voltage followers (AMP1, AMP2) of the preceding stage, the change of the output voltage of two voltage followers (AMP1, AMP2) of the preceding stage due to the change of the external power voltage (Vdd_ext) may possibly be set completely the same, thereby, the current which flows into plural series-connected voltage dividing resistors (R . . . R) of the first variable voltage divider (VDIV1) may possibly not change, causing no serious problem. However, the change of the output voltage of the third voltage follower (AMP3) of the latter stage, due to the change of the external power voltage (Vdd_ext), is unsolvable with the device of the layout of the CMOS device element.

As described above, the present invention is made based on the examination and the arduous clarification result of the mechanism of generation of mismatching, which have been performed by the present inventors in advance of the present invention. Therefore, the object of the present invention is to provide a semiconductor integrated circuit for RF communications which includes an RF-reception-signal analog signal processing subunit and an RF-transmission-signal analog signal processing subunit, and is operable to perform bidirectional signal transfer, by using a digital interface and LSI which perform a baseband digital signal processing. The RF-reception-signal analog signal processing subunit performs the frequency down-conversion of an RF reception signal to an analog baseband reception signal. The RF-transmission-signal analog signal processing subunit performs the frequency up-conversion of an analog baseband transmitting signal to an RF transmission signal. Moreover, the purpose of the present invention is, in the semiconductor integrated circuit for RF communications, to reduce the change of the AFC control analog output signal of an AFC-control D/A converter, due to the change of an external power voltage, wherein the AFC-control D/A converter controls the frequency of the reference frequency signal for generating the RF signal used for the frequency down-conversion and the frequency up-conversion. Moreover, another purpose of the present invention is to reduce the change of the oscillating frequency of the reference frequency signal, due to the change of the external power voltage.

The above and the other purposes and new features of the present invention will become clear from the description and the accompanying drawing of the present specification.

The outline of typical inventions among the inventions disclosed in the present application will be briefly explained hereinafter.

That is, according to one embodiment of the present invention, a semiconductor integrated circuit for RF communications (300), which performs bidirectional signal transfer using a digital interface and LSI (400) operable to perform at least a baseband digital signal processing, includes an RF-reception-signal analog signal processing subunit (301) and an RF-transmission-signal analog signal processing subunit (302).

The RF-reception-signal analog signal processing subunit (301) performs frequency down-conversion of an RF reception signal to analog baseband reception signals (RxABI, RxABQ), The RF-transmission-signal analog signal processing subunit (302) performs frequency up-conversion of analog baseband transmitting signals (TxABI, TxABQ) to an RF transmission signal.

The semiconductor integrated circuit for RF communications (300) includes a reference frequency oscillator (314) to generate a reference frequency signal for generating a high frequency signal which is used in the frequency down-conversion in the RF-reception-signal analog signal processing subunit (301), and in the frequency up-conversion in the RF-transmission-signal analog signal processing subunit (302). The semiconductor integrated circuit for RF communications (300) includes further an AFC-control D/A converter (315) which converts an AFC control digital input signal supplied from the LSI (400) to an AFC control analog output signal and controls frequency of the reference frequency signal which is generated from the reference frequency oscillator (314).

The AFC-control D/A converter (315) includes a first variable voltage divider (VDIV1) which generates analog rough selection voltages (Vr1, Vr2) in response to upper bits (D12 . . . D09) of the AFC control digital input signal, and a first voltage follower (AMP1) and a second voltage follower (AMP2) which are respectively supplied with one and the other voltage of the analog rough selection voltages (Vr1, Vr2). The AFC-control D/A converter (315) includes a second variable voltage divider (VDIV2) which is supplied with an output voltage of the first voltage follower (AMP1) and an output voltage of the second voltage follower (AMP2) and generates an analog fine selection voltage in response to lower bits (DO8 . . . D00) of the AFC control digital input signal, and a third voltage follower (AMP3) which is supplied with an output voltage of the second variable voltage divider (VDIV2) (refer to FIG. 11).

Each voltage follower of the first voltage follower (AMP1), the second voltage follower (AMP2), and the third voltage follower (AMP3) of the AFC-control D/A converter (315) is comprised of a CMOS rail-to-rail amplifier.

The CMOS rail-to-rail amplifier includes an NMOS differential input circuit (NMOS_DA), a PMOS differential input circuit (PMOS_DA), a CMOS output circuit (OUT_CKT), and a bias circuit (BIAS_CKT).

A non-inverted input terminal (Vinp) of the CMOS rail-to-rail amplifier is connected to the gate of the first NMOS (MN1) of the NMOS differential input circuit (NMOS_DA), and to the gate of the first PMOS (MP1) of the PMOS differential input circuit (PMOS_DA). An inverted input terminal (Vinn) of the CMOS rail-to-rail amplifier is connected to an output terminal (Vout), to the gate of the second NMOS (MN2) of the NMOS differential input circuit (NMOS_DA), and to the gate of the second PMOS (MP2) of the PMOS differential input circuit (PMOS_DA). The source of the first NMOS (MN1) and the source of the second NMOS (MN2) of the NMOS differential input circuit (NMOS_DA) are connected to the drain of the third NMOS (MN3) as the first current source transistor. The source of the first PMOS (MP1) and the source of the second PMOS (MP2) of the PMOS differential input circuit (PMOS_DA) are connected to the drain of the third PMOS (MP3) as the second current source transistor. The current of the third NMOS (MN3) as the first current source transistor of the NMOS differential input circuit (NMOS_DA), and the current of the third PMOS (MP3) as the second current source transistor of the PMOS differential input circuit (PMOS_DA) are set up by the bias circuit (BIAS_CKT), respectively.

The CMOS output circuit (OUT_CKT) includes an output PMOS (MP7) which pulls up the output voltage of the output terminal (Vout), in response to the first output signal from at least one of the first NMOS (MN1) and the second NMOS (MN2) of the NMOS differential input circuit (NMOS_DA). The CMOS output circuit (OUT_CKT) includes an output NMOS (MN9) which pulls down the output voltage of the output terminal (Vout), in response to the second output signal from at least one of the first PMOS (MP1) and the second PMOS (MP2) of the PMOS differential input circuit (PMOS_DA).

The semiconductor integrated circuit for RF communications (300) includes further a reference voltage generator (RVG) which generates, from a power supply voltage (Vdd_ext), an internal regulated power supply voltage (Vdd_int) maintained almost stable.

In the CMOS rail-to-rail amplifier which constitutes the first voltage follower (AMP1), the second voltage follower (AMP2), and the third voltage follower (AMP3) of the AFC-control D/A converter (315), the power supply voltage (Vdd_ext) is supplied to the NMOS differential input circuit (NMOS_DA), the bias circuit (BIAS_CKT), and the CMOS output circuit (OUT_CKT).

In the CMOS rail-to-rail amplifier which constitutes at least the third voltage follower (AMP3) of the AFC-control D/A converter (315), the internal regulated power supply voltage (Vdd_int) generated from the reference voltage generator (RVG) is supplied to the PMOS differential input circuit (PMOS_DA) (refer to FIG. 10).

According to the above-mentioned means, in the CMOS rail-to-rail amplifier which constitutes at least the third voltage follower (AMP3) of the AFC-control D/A converter (315), the internal regulated power supply voltage (Vdd_int) which is generated from the reference voltage generator (RVG) and which is maintained almost stable is supplied to the PMOS differential input circuit (PMOS_DA). Therefore, even if a power supply voltage (Vdd_ext) changes, the level of the internal regulated power supply voltage (Vdd_int) is controlled to a very small change. Consequently, increase of a current value of the third PMOS (MP3) as the second current source transistor of the PMOS differential input circuit (PMOS_DA), due to the change of the power supply voltage (Vdd_ext), is also controlled to a small increase. At this time, even if there are some shifting of the pair nature of the electrical property of the first PMOS (MP1) and the second PMOS (MP2) of the PMOS differential input circuit (PMOS_DA), the input offset voltage Vinoffset (P) of the PMOS differential input circuit (PMOS_DA) does not increase, and finally, change of an AFC control analog output signal (V_{TUNE}) of the AFC-control D/A converter (AFCDAC) 315 can be reduced.

The first feature of fundamental technical thought in the one embodiment of the present invention lies in the fact that the AFC-control D/A converter (315) controls frequency of the reference frequency signal generated from the reference frequency oscillator (314) which generates a reference frequency signal for generating a high frequency signal used for the frequency down-conversion and the frequency up-conversion in the semiconductor integrated circuit for RF communications (300). Each of the first voltage follower (AMP1), the second voltage follower (AMP2), and the third voltage follower (AMP3) of the AFC-control D/A converter (315) is comprised of a CMOS rail-to-rail amplifier. Although Non Patent Document 4 describes the CMOS rail-to-rail amplifier, Non Patent Document 4 fails to describe the AFC-control D/A converter which controls frequency of the reference frequency signal generated from the reference frequency oscillator which generates a reference frequency signal for generating a high frequency signal used for the frequency down-conversion and the frequency up-conversion of an RF analog signal processing integrated circuit.

The second feature of fundamental technical thought in the one embodiment of the present invention lies in the fact that in the voltage followers (AMP1, AMP2, AMP3), the inverted input terminal (Vinn) of the CMOS rail-to-rail amplifier is connected to the output terminal (Vout), to the gate of the second NMOS (MN2) of the NMOS differential input circuit (NMOS_DA), and to the gate of the second PMOS (MP2) of the PMOS differential input circuit (PMOS_DA). Although Non Patent Document 4 describes the CMOS rail-to-rail amplifier, Non Patent Document 4 fails to describe a voltage follower which uses the CMOS rail-to-rail amplifier.

The third feature of fundamental technical thought in the one embodiment of the present invention lies in the fact that in the CMOS rail-to-rail amplifier which constitutes at least the latter-stage third voltage follower (AMP3) of the AFC-control D/A converter (315), the internal regulated power supply voltage (Vdd_int), which is generated from the reference voltage generator (RVG) and which is maintained almost stable, is supplied to the PMOS differential input circuit (PMOS_DA). Consequently, even if the power supply voltage (Vdd_ext) changes, the level of the internal regulated power supply voltage (Vdd_int) is controlled to a very small change. Consequently, increase of a current value of the third PMOS (MP3) as the second current source transistor of the PMOS differential input circuit (PMOS_DA), due to the change of the power supply voltage (Vdd_ext), is also controlled to a small increase. At this time, even if there are some shifting in the pair nature of the electrical property of the first and the second PMOS (MP1, MP2) of the PMOS differential input circuit (PMOS_DA), the input offset voltage Vinoffset (P) of the PMOS differential input circuit (PMOS_DA) does not increase. Finally, an operation and an effect referred to as being able to reduce change of the AFC control analog output signal (V_{TUNE}) of the AFC-control D/A converter (AFCDAC) 315 can be enjoyed.

Non Patent Document 4 describes the fact that, in order to set constant a gain bandwidth product of the rail-to-rail amplifier, an about −1.2V stable internal power supply voltage Vint is generated from an external power voltage Vext of 1.3V or more, by a negative feedback voltage generation circuit, and supplied to the source of a PMOS constant current transistor of a PMOS differential input circuit. Consequently, according to Non Patent Document 4, an operation and an effect referred to as being able to satisfy cross point conditions of the NMOS differential input circuit and the PMOS differential input circuit can be enjoyed. However, Non Patent Document 4 fails to describe an operation and an effect regarding the reduction of increasing input offset voltage of the PMOS differential input circuit due to shifting in the pair nature of the electrical property of the PMOS differential pair of the PMOS differential input circuit, the shifting being brought by increase of the external power voltage Vext.

In the semiconductor integrated circuit for RF communications (300) according to a preferred embodiment of the present invention, the internal regulated power supply voltage (Vdd_int) generated from the reference voltage generator (RVG) is supplied to the first variable voltage divider (VDIV1) of the AFC-control D/A converter (315) as a reference voltage (V_{REF}) (refer to FIG. 10).

The semiconductor integrated circuit for RF communications (300) according to the preferred embodiment of the present invention includes a phase comparator (PDC) of which one input terminal is supplied with the reference frequency signal of the reference oscillating frequency f_{REF} created by the reference frequency oscillator (314), a charge pump circuit (CPC) which responds to an output of the phase comparator (PDC), and a low pass filter (LFC) which responds to an output of the charge pump circuit (CPC). The semiconductor integrated circuit for RF communications (300) includes further an RF voltage controlled oscillator (RFVCO) which responds to a control output voltage (VCNT) of the low pass filter (LFC), and a divider (DIV) connected between an output terminal of the RF voltage controlled oscillator (RFVCO) and another input terminal of the phase comparator (PDC). A PLL circuit which includes the phase comparator (PDC), the charge pump circuit (CPC), the low pass filter (LFC), the RF voltage controlled oscillator (RFVCO), and the divider (DIV) serves as a frequency synthesizer (Frct_Synth). The semiconductor integrated circuit for RF communications (300) possesses an RF-transmission voltage controlled oscillator (TXVCO) which generates an RF transmission frequency signal for an RF transmission signal of RF communication, by using an RF oscillation output signal (f_{RFVCO}) fed at the output terminal of the RF voltage controlled oscillator in the PLL circuit. The PLL circuit which serves as the frequency synthesizer (Frct_Synth) is a fractional PLL circuit in which an average division ratio includes an integer and a fraction by changing a dividing ratio of the divider (DIV) (refer to FIG. 14).

According to the above-mentioned means, when the semiconductor integrated circuit for RF communications performs transmission and reception operations with a base station, a precise frequency resolution can be obtained. Severe specifications about a severe neighboring disturbance signal of GMSK in frequency spectra of an RF transmission signal of a mobile phone terminal apparatus of the GSM system can also be satisfied (refer to FIG. 18).

In the semiconductor integrated circuit for RF communications (300) according to a more preferred embodiment of the present invention, the PLL circuit which serves as the frequency synthesizer (Frct_Synth) includes an intermediate frequency divider (IF DIV) which generates an intermediate frequency signal (f_{IF DIV}) by dividing the RF oscillation output signal (f_{RFVCO}) generated by the RF voltage controlled oscillator (RFVCO). The semiconductor integrated circuit for RF communications (300) includes transmission mixers (TX-MIX_I, TX-MIX_Q) and a transmission-system offset PLL circuit (TX_Offset_PLL). The transmission mixers (TX-MIX_I, TX-MIX_Q) create an intermediate frequency transmitting signal from the intermediate frequency signal (f_{IF DIV}) which is generated by the intermediate frequency divider (IF DIV) and transmitting baseband signals (TxABI, TxABQ). The PLL circuit includes an RF divider (RF DIV) which generates a dividing RF frequency signal by dividing the RF oscillation output signal (f_{RFVCO}) generated by the RF voltage controlled oscillator (RFVCO). The transmission-system offset PLL circuit (TX_Offset_PLL) includes a phase comparator circuit (PC) of which one input terminal is supplied with the intermediate frequency transmitting signal generated by the transmission mixers (TX-MIX_I, TX-MIX_Q), and an RF-transmission voltage controlled oscillator (TXVCO) which responds to an output of the phase comparator circuit (PC). The transmission-system offset PLL circuit (TX_Offset_PLL) includes a phase-controlled-feedback frequency down mixer (DWN_MIX_PM). One input terminal of the phase-controlled-feedback frequency down mixer (DWN_MIX_PM) is supplied with the RF transmission frequency signal (f_{TXVCO}) generated by the RF-transmission voltage controlled oscillator (TXVCO), and another input terminal of the phase-controlled-feedback frequency down mixer (DWN_MIX_PM) is supplied with the dividing RF frequency signal generated by the RF divider (RF DIV). An output signal of the phase-controlled-feedback frequency down mixer (DWN_MIX_PM) is supplied to another input terminal of the phase comparator circuit (PC) (refer to FIG. 15).

In the semiconductor integrated circuit for RF communications (300) according to a further preferred embodiment of the present invention, the RF-reception-signal analog signal processing subunit (RX SPU) includes low-noise amplifiers (LNA1-LNA4) which amplify an RF reception signal. The RF-reception-signal analog signal processing subunit (RX SPU) includes receive mixers (RX-MIX_I, RX-MIX_Q) which generate receiving baseband signals (RxABI, RxABQ) upon being supplied with an RF-amplified reception output signal generated by the low-noise amplifiers (LNA1-LNA4). The PLL circuit which serves as the frequency synthesizer (Frct_Synth) includes a first divider (DIV1) and a second divider (DIV4). The first divider (DIV1) creates an RF carrier signal to be supplied to the receive mixers (RX-MIX_I, RX-MIX_Q), by dividing the RF oscillation output signal of the oscillating frequency (f_{RFVCO}) generated by the RF voltage controlled oscillator. The second divider (DIV4) divides the output signal of the first divider (DIV1).

A case where the semiconductor integrated circuit for RF communications (300) receives the RF reception signal of a frequency band of GSM 850 MHz or a frequency band of GSM 900 MHz is assumed. In this case, a dividing output signal generated by the first divider (DIV1) is transferred to the receive mixers (RX-MIX_I, RX-MIX_Q) as the RF carrier signal. Thereby, the receiving baseband signals (RxABI, RxABQ), which are frequency-converted from the RF reception signal of the frequency band of the GSM 850 MHz, or of the frequency band of the GSM 900 MHz by the receive mixers (RX-MIX_I, RX-MIX_Q), are generated.

A case where the semiconductor integrated circuit for RF communications (300) receives the RF reception signal of a frequency band of DCS 1800 MHz or a frequency band of PCS 1900 MHz is assumed. In this case, the RF oscillation output signal of the oscillating frequency (f_{RFVCO}) generated by the RF voltage controlled oscillator (RFVCO) is transferred to the receive mixers (RX-MIX_I, RX-MIX_Q) as the RF carrier signal. Thereby, the receiving baseband signals (RxABI, RxABQ), which are frequency-converted from the RF reception signal of the frequency band of the DCS 1800 MHz or the frequency band of the PCS 1900 MHz, are generated.

A case where the semiconductor integrated circuit for RF communications (300) creates the RF transmission frequency signal of a frequency band of GSM 850 MHz or a frequency band of GSM 900 MHz is assumed. In this case, the intermediate frequency transmitting signal is created from the intermediate frequency signal and the transmitting baseband signals (TxABI, TxABQ) by the transmission mixers (TX-MIX_I, TX-MIX_Q), and the first divider (DIV1) and the second divider (DIV4) operate as the RF divider (RF DIV). Thereby, the dividing output signal of the second divider (DIV4) is transferred to the other input terminal of the phase-controlled-feedback frequency down mixer (DWN_MIX_PM) in the transmission-system offset PLL circuit (TX_Offset_PLL) as the dividing RF frequency signal. In the transmission-system offset PLL circuit (TX_Offset_PLL), the intermediate frequency transmitting signal is frequency-converted to the RF transmission frequency signal (f_{TXVCO}) of the frequency band of the GSM 850 MHz, or the frequency band of the GSM 900 MHz.

A case where the semiconductor integrated circuit for RF communications (300) creates the RF transmission frequency signal of a frequency band of DCS 1800 MHz or a frequency band PCS 1900 MHz is assumed. In this case, the intermediate frequency transmitting signal is created from the intermediate frequency signal and the transmitting baseband signals (TxABI, TxABQ) by the transmission mixers (TX-MIX_I, TX-MIX_Q), and the first divider (DIV1) operates as the RF divider (RF DIV). Thereby, the dividing output signal of the first divider (DIV1) is transferred to the other input terminal of the phase-controlled-feedback frequency down mixer (DWN_MIX_PM) in the transmission-system offset PLL circuit (TX_Offset_PLL) as the dividing RF frequency signal. In the transmission-system offset PLL circuit (TX_Offset_PLL), the intermediate frequency transmitting signal is frequency-converted to the RF transmission frequency signal (f_{TXVCO}) of the frequency band of the DCS 1800 MHz, or the frequency band of the PCS 1900 MHz (refer to FIG. 15).

According to the further preferred embodiment of the present invention described above, reception and transmission of four frequency bands, GSM 850 MHz, GSM 900 MHz, DCS 1800 MHz, and PCS 1900 MHz, become possible.

The semiconductor integrated circuit for RF communications (300) according to a more concrete embodiment of the present invention is constituted by a polar loop system for supporting an EDGE (Enhanced Data for GSM Evolution; Enhanced Data for GPRS) system. The transmission-system offset PLL circuit (TX_Offset_PLL) includes a phase loop (PM LP) for phase modulation of the polar loop system, and an amplitude loop (AM LP) of the polar loop system. The phase comparator circuit (PC), the RF-transmission voltage controlled oscillator (TXVCO), and the phase-controlled-feedback frequency down mixer (DWN_MIX_PM) in the transmission-system offset PLL circuit (TX_Offset_PLL) constitute the phase loop (PMLP) (refer to FIG. 16).

According to the means of the more concrete embodiment of the present invention, the EDGE system of a high communication data transfer rate which uses amplitude modulation as well as phase modulation can be supported.

The semiconductor integrated circuit for RF communications (300) according to a more concrete embodiment of the present invention is constituted by a polar modulator system to support the EDGE system. The transmission-system offset PLL circuit (TX_Offset_PLL) includes a phase loop (PM LP) for phase modulation of the polar modulator system, and an amplitude loop (AM LP) of the polar modulator system. The phase comparator circuit (PC), the RF-transmission voltage controlled oscillator (TXVCO), and the phase-controlled-feedback frequency down mixer (DWN_MIX_PM) in the transmission-system offset PLL circuit (TX_Offset_PLL) constitute the phase loop (PM LP) (refer to FIG. 17).

According to the means of the more concrete embodiment of the present invention, the EDGE system of a high communication data transfer rate which uses amplitude modulation as well as phase modulation can be supported.

In the semiconductor integrated circuit for RF communications (300) according to another embodiment of the present invention, the RF-reception-signal analog signal processing subunit (RX SPU) includes low-noise amplifiers (LNA1-LNA4) which amplify an RF reception signal. The RF-reception-signal analog signal processing subunit (RX SPU) includes receive mixers (RX-MIX_I, RX-MIX_Q) which generate receiving baseband signals (RxABI, RxABQ), by being supplied with an RF-amplified reception output signal generated by the low-noise amplifiers (LNA1-LNA4), and a receiving carrier signal generated by the frequency synthesizer (Frct_Synth). The RF-transmission-signal analog signal processing subunit (TX SPU) includes transmission mixers (TX-MIX_I, TX-MIX_Q) to which transmitting baseband signals (TxABI, TxABQ) is supplied, and a transmitting carrier signal generated by the frequency synthesizer (Frct_Synth) is supplied to the RF-transmission-signal analog signal processing subunit (TX SPU). Thereby, the RF-transmission-signal analog signal processing subunit (TX SPU) generates RF transmission signals (Tx_GSM850, Tx_GSM900, Tx_DCS1800, Tx_PCS1900) (refer to FIG. 15).

The semiconductor integrated circuit for RF communications (300) according to the more concrete embodiment of the present invention includes a ΣΔ-modulator (ΣΔMod) for the fractional PLL circuit to calculate the decimal of the average division ratio (refer to FIG. 14).

An effect acquired by typical one of the inventions disclosed in the present application is explained briefly in the following.

Namely, according to the present invention, it is possible to reduce the change of the AFC control analog output signal for the AFC-control D/A converter due to the change of the external power voltage, the AFC-control D/A converter being for controlling frequency of the reference frequency signal for generating a high frequency signal used for the frequency down-conversion and the frequency up-conversion. According to the present invention, it is possible to reduce the change of the oscillating frequency of the reference frequency signal due to the change of the external power voltage.

### BRIEF DESCRIPTION OF THE DRAWINGS

FIG. 1 is a block diagram illustrating an entire constitution of a mobile terminal device which mounts an RF IC and a baseband LSI with a digital interface examined by the present inventors in advance of the present invention, and also a block diagram illustrating an entire constitution of a mobile terminal device according to one embodiment of the present invention;

FIG. 2 is a circuit diagram illustrating constitution of an AFC-control D/A converter arranged in the RF analog signal processing integrated circuit of the mobile terminal device illustrated in FIG. 1;

FIG. 3 is a circuit diagram illustrating constitution of a CMOS rail-to-rail amplifier which constitutes three voltage followers of the AFC-control D/A converter illustrated in FIG. 2;

FIG. 4 is a drawing of simulation result illustrating change of an AFC control analog output signal of the AFC-control D/A converter illustrated in FIG. 2 due to the change of an external power voltage when 100% of pair nature of the electrical property of differential pair MOS is attained;

FIG. 5 is a drawing of simulation result illustrating change of the AFC control analog output signal of the AFC-control D/A converter illustrated in FIG. 2 due to the change of the external power voltage when the pair nature of the electrical property of the differential pair NMOS of the NMOS differential input circuit of FIG. 3 shifts 10%;

FIG. 6 is a drawing of simulation result illustrating change of the AFC control analog output signal of the AFC-control D/A converter illustrated in FIG. 2 due to the change of the external power voltage when the pair nature of the electrical property of the differential pair PMOS of the PMOS differential input circuit of FIG. 3 shifts 10%;

FIG. 7 is a drawing of simulation result illustrating change of the AFC control analog output signal of the AFC-control D/A converter illustrated in FIG. 2 due to the change of the external power voltage when the pair nature of the electrical property of the differential pair NMOS of an NMOS differential input circuit of FIG. 3 shifts 10% and the pair nature of the electrical property of differential pair PMOS of the PMOS differential input circuit of FIG. 3 shifts 10%;

FIG. 8 is a drawing of simulation result illustrating change of the AFC control analog output signal of the AFC-control D/A converter illustrated in FIG. 2 due to the change of the external power voltage when the pair nature of the electrical property of the differential pair NMOS of the NMOS differential input circuit of FIG. 3 shifts 10% and the pair nature of the electrical property of the differential pair PMOS of the PMOS differential input circuit of FIG. 3 shifts 10%;

FIG. 9 is a drawing of an experimental result illustrating change of an AFC control analog output signal measured on an semiconductor chip containing an AFC-control D/A converter, the semiconductor chip having been actually made for trial;

FIG. 10 is a circuit diagram illustrating constitution of a CMOS rail-to-rail amplifier which constitutes three voltage followers of the AFC-control D/A converter of the mobile terminal device of FIG. 1 as one embodiment of the present invention;

FIG. 11 is a circuit diagram illustrating constitution of an AFC-control D/A converter arranged in the RF analog signal processing integrated circuit of the mobile terminal device illustrated in FIG. 1 as one embodiment of the present invention;

FIG. 12 is a drawing of simulation result illustrating change of the AFC control analog output signal of the AFC-control D/A converter illustrated in FIG. 11 when the source of the current source transistor of the PMOS differential input circuit of the CMOS rail-to-rail amplifier illustrated in FIG. 10 is connected to an external power voltage as conventional instead of the internal regulated power supply voltage;

FIG. 13 is a drawing of simulation result illustrating change of the AFC control analog output signal of the AFC-control D/A converter illustrated in FIG. 11 when the source of the current source transistor of the PMOS differential input circuit of the CMOS rail-to-rail amplifier illustrated in FIG. 10 is connected to the internal regulated power supply voltage according to the embodiment of the present invention, instead of an external power voltage;

FIG. 14 is a drawing illustrating constitution of a fractional synthesizer of a fractional-N PLL arranged in the RF analog signal processing integrated circuit of the mobile terminal device illustrated in FIG. 1 as one embodiment of the present invention;

FIG. 15 is a drawing illustrating constitution of the RF analog signal processing integrated circuit RF IC according to a more concrete embodiment of the present invention;

FIG. 16 is a drawing illustrating constitution of the RF analog signal processing integrated circuit RF IC according to a still more concrete embodiment of the present invention;

FIG. 17 is a drawing illustrating constitution of the RF analog signal processing integrated circuit RF IC according to another concrete embodiment of the present invention;

FIG. 18 is a drawing illustrating frequency spectra of an RF transmission signal of a mobile phone terminal apparatus specified by GMSK specification; and

FIG. 19 is a circuit diagram illustrating another constitution of a CMOS rail-to-rail amplifier which constitutes three voltage followers of the AFC-control D/A converter of the mobile terminal device of FIG. 1 as one embodiment of the present invention.

### DETAILED DESCRIPTION OF THE PREFERRED EMBODIMENTS

### <<Entire Constitution of the Mobile Terminal Device>>

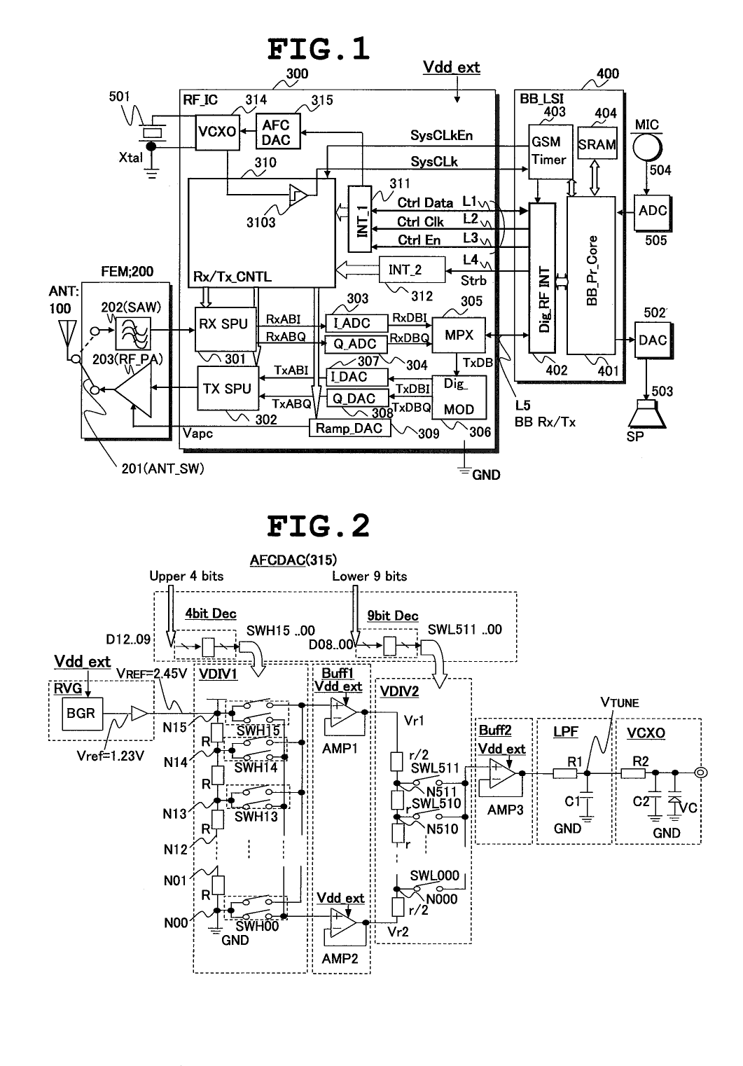

FIG. 1 is a drawing illustrating an entire constitution of a mobile terminal device according to one embodiment of the present invention. Although the mobile terminal device in the present description assumes a mobile phone terminal device, alternatively, it may be a mobile communication device for a notebook-size personal computer or for a PDA (Personal Digital Assist) device. In the mobile terminal device illustrated in FIG. 1, A/D converters 303, 304 and D/A converters 307, 308, 315 are arranged in the RF analog signal processing integrated circuit (RF_IC) 300. Namely, the A/D converters 303 and 304 converts analog baseband signals RxABI and RxABQ into digital baseband signals RxDBI and RxDBQ and supplies the digital baseband signals RxDBI and RxDBQ to a baseband signal processing LSI (BB_LSI) 400, wherein the analog baseband signals RxABI and RxABQ are an output of an RF-reception-signal analog signal processing subunit (RX SPU) 301 in the RF analog signal processing integrated circuit (RF_IC) 300. The D/A converters 307 and 308 convert quadrature components TxDBI and TxDBQ of a digital baseband transmitting signal of an output of the baseband signal processing LSI (BB_LSI) 400 into analog baseband transmitting signals TxABI and TxABQ. The D/A converters 307 and 308 supply an RF-transmission-signal analog signal processing subunit (TX SPU) 302 in the RF analog signal processing integrated circuit (RF_IC) 300 with the analog baseband transmitting signals TxABI and TxABQ. Furthermore, the AFC-control D/A converter (AFCDAC) 315 converts an AFC control digital signal into an AFC control analog signal, and supplies it to a system reference clock oscillator (VCXO) 314. Here, the AFC control digital signal is an output of a baseband processor core 401, obtained by a digital signal path L3 of an RF digital interface 402 of the baseband signal processing LSI 400.

In order that the mobile phone terminal device may perform receiving operation from a base station and a send operation to the base station, an antenna (ANT) 100 receives a reception signal of radio frequency (called RF hereinafter) from the base station, and outputs an RF transmission signal to the base station. The antenna 100 is connected to a front-end module (FEM) 200. The front-end module 200 has an antenna switch (ANT_SW) 201. When the antenna switch 201 is connected to the upper side, the RF reception signal received with the antenna 100 is supplied to a receive filter (SAW) 202 made of a surface acoustic wave device (passing a desired frequency signal, and decreasing a disturbing frequency signal). On the other hand, when the antenna switch 201 is connected to the down side, the antenna switch 201 is connected to an output of a transmission RF power amplifier (RF_PA) 203. Therefore, an RF transmission signal is outputted from the antenna 100 to the base station by RF power output of the transmission RF power amplifier 203. The antenna switch 201 of the front-end module 200 is connected to the upper side in a time slot of receiving operation of the TDMA (Time Sharing Multiple Access) system, and it is connected to the down side in a time slot of send operation.

An RF reception signal of the output of the receive filter 202 of the front-end module 200 is supplied to an input of the RF-reception-signal analog signal processing subunit (RX SPU) 301 arranged in the RF analog signal processing integrated circuit (RF_IC) 300 as an RF analog signal processing unit. On the other hand, an RF input of the transmission RF power amplifier 203 of the front-end module 200 is connected to an output of the RF-transmission-signal analog signal processing subunit (TX SPU) 302 in the RF analog signal processing integrated circuit 300.

<<Entire Constitution of the RF Analog Signal Processing Integrated Circuit>>

Next, the RF analog signal processing integrated circuit 300, which performs signal transfer bidirectionally with the baseband digital LSI 400 via the digital interface, is explained in detail.

First, the RF analog signal processing integrated circuit 300 includes the RF-reception-signal analog signal processing subunit 301 and the RF-transmission-signal analog signal processing subunit 302. The RF-reception-signal analog signal processing subunit 301 performs frequency down-conversion of the RF reception signal into the analog baseband reception signals RxABI and RxABQ, and the RF-transmission-signal analog signal processing subunit 302 performs frequency up-conversion of the analog baseband transmitting signals TxABI and TxABQ into the RF transmission signal. The RF analog signal processing integrated circuit 300 includes the reference frequency oscillator 314 which generates the reference frequency signal for generating a high frequency signal, which is used for the frequency down-conversion in the RF-reception-signal analog signal processing subunit 301, and the frequency up-conversion in the RF-transmission-signal analog signal processing subunit 302. The RF analog signal processing integrated circuit 300 includes further the AFC-control D/A converter 315 operable to control frequency of the reference frequency signal, which is generated by the reference frequency oscillator 314, by converting an AFC control digital input signal supplied from the baseband LSI 400 into an AFC control analog output signal.

The RF-reception-signal analog signal processing subunit 301 in the RF analog signal processing integrated circuit 300 creates quadrature components RxABI and RxABQ of the analog baseband reception signal from the RF reception signal supplied by the receive filter 202. These quadrature components RxABI and RxABQ are supplied to an input of the A/D converter (I_ADC) 303 for analog-baseband reception signal I, and an input of the A/D converter (Q_ADC) 304 for analog-baseband reception signal Q. The A/D converters 303 and 304 for the analog baseband reception signals I and Q convert the supplied analog baseband reception signals RxABI and RxABQ into digital baseband reception signals RxDBI and RxDBQ. These digital baseband reception signals RxDBI and RxDBQ are supplied to two inputs of a multiplexer (MPX) 305. The multiplexer 305 is connected to the baseband signal processing LSI (BB_LSI) 400, which is a baseband digital signal processing unit, via a bidirectional digital signal path L5. The bidirectional digital signal path L5 possesses one signal line (1 bit), therefore, in receiving operation, two digital baseband reception signals RxDBI and RxDBQ are supplied to the baseband signal processing LSI 400 by time sharing.

In send operation, the multiplexer 305 outputs a digital baseband transmitting signal TxDB fed by the baseband signal processing LSI 400 via the bidirectional digital signal path L5, which possesses one signal line (1 bit), to a digital baseband modulator (Dig_MOD) 306. The digital baseband modulator 306 creates quadrature components TxDBI and TxDBQ of the digital baseband transmitting signals from the digital baseband transmitting signal TxDB supplied by the multiplexer 305. These quadrature components TxDBI and TxDBQ are supplied to an input of the D/A converter (I_DAC) 307 for the digital baseband transmitting signal I, and to an input of the D/A converter (Q_DAC) 308 for the digital baseband transmitting signal Q, respectively. The D/A converters 307 and 308 for the digital baseband transmitting signals I and Q convert the supplied digital baseband transmitting signals TxDBI and TxDBQ into analog baseband transmitting signals TxABI and TxABQ. These analog baseband transmitting signals TxABI and TxABQ are supplied to the input of the RF-transmission-signal analog signal processing subunit (TX SPU) 302 in the RF analog signal processing integrated circuit 300. The RF-transmission-signal analog signal processing subunit 302 creates an RF transmission signal from the analog baseband transmitting signal TxABI and TxABQ, and supplies the RF transmission signal to the transmission RF power amplifier 203 as an RF power input. The transmission RF power amplifier 203 amplifies the RF power input to create an RF power output from the RF-amplified output. An amplification gain of the transmission RF power amplifier 203 is set up by an automatic power control voltage Vapc created by a ramp-signal D/A converter (Ramp DAC) 309 in the RF analog signal processing integrated circuit 300. Not only the operating condition of the ramp-signal D/A converter 309 but the operating conditions of the RF-reception-signal analog signal processing subunit 301 and of the RF-transmission-signal analog signal processing subunit 302 are controlled by a transmitting/receiving control subunit (Rx/Tx_CTRL) 310 in the RF analog signal processing integrated circuit 300. The transmitting/receiving control subunit 310 is connected with the baseband signal processing LSI 400 via a first interface (INT_1) 311, a second interface (INT_2) 312 and digital signal paths L1, L2, L3, and L4.

<<A Digital-Interface of the RF Analog Signal Processing Integrated Circuit>>

The digital signal of the digital signal path L1 is control data (Ctrl Data) supplied from the baseband signal processing LSI 400, and the control data includes an instruction code for setting-operation, and control information for executing the instruction. The digital signal of the digital signal path L2 is a control clock (Ctrl CLk) supplied from the baseband signal processing LSI 400, and the control clock is a synchronous control signal for the setting-operation. The digital signal of the digital signal path L3 is a control enable signal (Ctrl En) supplied from the baseband signal processing LSI 400. The control enable signal (Ctrl En) is driven to a level which makes enabling possible by the baseband signal processing LSI 400, when the baseband signal processing LSI 400 sets up an operating condition of the transmission/reception operation of an internal circuitry in the RF analog signal processing integrated circuit 300 and the transmission/reception operation of the front-end module 200. On the other hand, the digital signal of the digital signal path L4 is a strobe signal (Strb) used by a special operation mode of operation setting which makes plural time slots one setting unit. In this special operation mode, before outputting the strobe signal (Strb) to the digital signal path L4, reservation of operation setting which makes plural time slots one setting unit is performed. After the completion of reservation of operation setting in this special operation mode, a strobe signal (Strb) is supplied to the second interface (INT_2) 312 of the RF analog signal processing integrated circuit 300. This strobe signal (Strb) determines to which timing of time slots the instruction code for the reserved operation setting and the control information for executing the instruction are supplied to the RF analog signal processing subunits 301 and 302 and to the front-end module 200 from the transmitting/receiving control subunit 310.

<<A System Reference Clock Oscillator of the RF Analog Signal Processing Integrated Circuit>>

The RF analog signal processing integrated circuit 300 has a system reference clock oscillator (VCXO) 314. The oscillating frequency of a system reference clock signal SysCLk created in terms of an output of the system reference clock oscillator 314 can be maintained stable by a crystal oscillator (Xtal) 501 outside the integrated-circuit 300 and an AFC control analog signal for automatic frequency control supplied by the AFC-control D/A converter (AFCDAC) 315. The AFC control digital signal supplied to the AFC-control D/A converter (AFCDAC) 315 is low speed data at several 10 to several 100 kHz, which is a kind of control data (Ctrl Data) supplied to the first interface (INT_1) 311 from the baseband processor core 401 of the baseband signal processing LSI 400 via the digital signal path L1. The baseband processor core 401 of the baseband signal processing LSI 400 generates, by means of digital signal processing of the digital baseband signal, the AFC control digital signal which serves as to compensate the deviation from the desired value of 26 MHz of the oscillating frequency of the system reference clock signal SysCLk of the system reference clock oscillator (VCXO) 314. The AFC control digital signal is converted into the AFC control analog signal by the D/A converter (AFCDAC) 315, and then the capacity of a variable capacitance element of the system reference clock oscillator (VCXO) 314 is controlled by the AFC control analog signal. Consequently, the oscillating frequency of the system reference clock signal SysCLk of the system reference clock oscillator (VCXO) 314 comes to be in agreement with the desired value of 26 MHz.

<<Transmission and Reception Operations of the Mobile Terminal Device>>

Next, transmission and reception operations of the mobile terminal device are explained. The baseband signal processing LSI 400 establishes communication of the GSM system or the EDGE system using the RF analog signal processing integrated circuit 300 and the front-end module 200. In that case, a GSM timer (GSM Timer) 403 in the baseband signal processing LSI 400 supplies a system-reference-clock-signal enabling signal SysCLkEn to the RF analog signal processing integrated circuit 300. Then, the system reference clock signal SysCLk created in terms of the output of the system reference clock oscillator 314 of the RF analog signal processing integrated circuit 300 is supplied to the GSM timer (GSM Timer) 403 in the baseband signal processing LSI 400, via a wave-shaping circuit 3103 of the transmitting/receiving control subunit 310. This information is supplied also to the baseband processor core (BB_Pr_Core) 401 in the baseband signal processing LSI 400. Then, a CPU in the baseband processor core 401 starts operation setting of a time slot in the time sharing multiple access system, via the RF digital interface (Dig_RF_INT) 402 and the digital signal paths L1, L2, L3, L4. A digital signal processor (DSP) in the baseband processor core 401 performs signal processing about a receiving baseband signal processed by the RF-reception-signal analog signal processing subunit 301 of the RF analog signal processing integrated circuit 300. By this signal processing, when communication established in advance is the GSM system, phase demodulation is performed by generating a phase modulation component. By the result of the phase demodulation, an audio signal of conversation of a communications partner is obtained with a D/A converter (DAC) 502 and a speaker (SP) 503 outside the baseband signal processing LSI 400. On the other hand, an analog audio signal uttered by a user who uses the mobile terminal device of FIG. 1 is converted into a digital audio signal by a microphone (MIC) 504 and an A/D converter (ADC) 505. The digital signal processor (DSP) in the baseband processor core 401 performs signal processing about this digital audio signal. By this signal processing, when communication established in advance is the GSM system, phase modulation is performed. Consequently, it becomes possible to include the phase modulation component in the transmitting baseband signal which should be processed by the RF-transmission-signal analog signal processing subunit 302 of the RF analog signal processing integrated circuit 300. When communication established in advance is the EDGE system, since not only the phase modulation component but the amplitude modulation component is included in the communicative transmitting/receiving information, a communicative data transfer rate can be improved. The baseband signal processing LSI 400 has an SRAM 404 as an internal memory, which can be used as a work memory in the case of communication of the GSM system or the EDGE system.

The baseband signal processing LSI 400 is connectable with an external nonvolatile memory (not shown) and an application processor (not shown). The application processor is connected to a liquid crystal display device (not shown) and a key input device (not shown), and is able to execute various application programs containing a general program and a game. A boot program (a start-up initializing program) of mobile devices including a mobile phone, an operating system program (OS), a program for phase demodulation about a receiving baseband signal and phase modulation about a transmitting baseband signal of the GSM system by the digital signal processor (DSP) in the baseband signal processing LSI 400, and various application programs can be stored in an external nonvolatile memory.

<<CMOS Rail-to-Rail-Amplifier>>

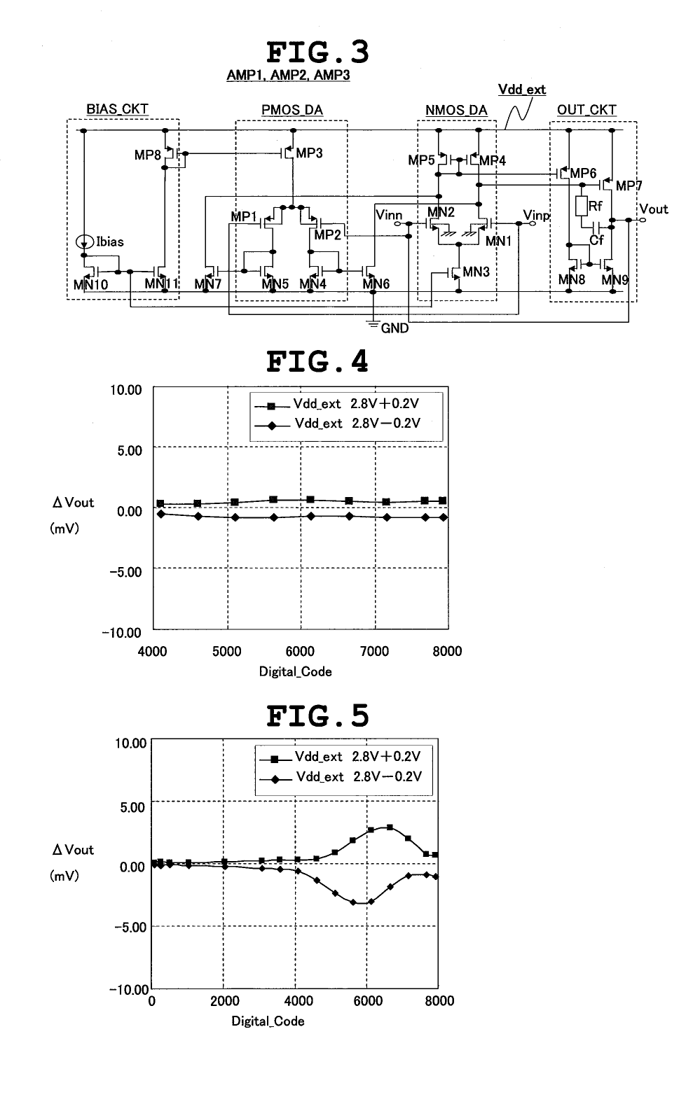

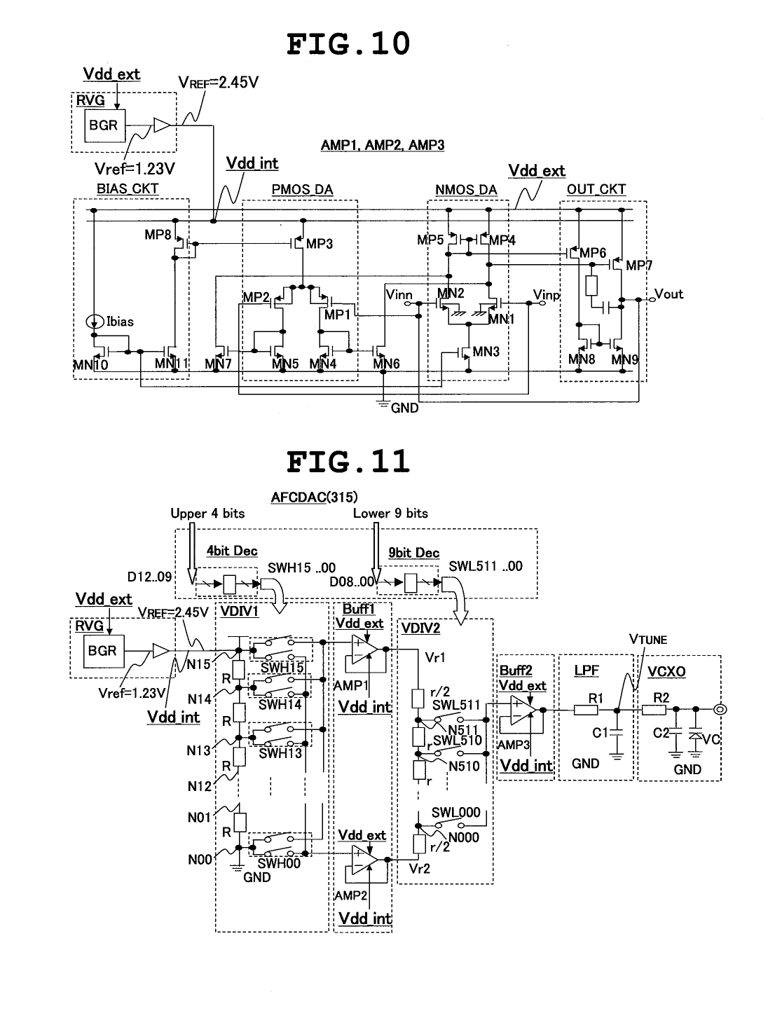

FIG. 10 is a circuit diagram illustrating constitution of a CMOS rail-to-rail amplifier which constitutes three voltage followers (AMP1, AMP2, AMP3) of the AFC-control D/A converter (AFCDAC) 315 of the mobile terminal device of FIG. 1 as one embodiment of the present invention. The point that the CMOS rail-to-rail amplifier of FIG. 10 is different from the CMOS rail-to-rail amplifier illustrated in FIG. 3 is, for the first place, that a reference voltage generator RVG, which generates internal regulated power supply voltage Vdd_int maintained stable to about 2.45 V from the external power voltage Vdd_ext of a standard value of 2.8 V with the range of fluctuation from 2.67 V (minimum) to 3.0 V (maximum), is included in the CMOS rail-to-rail amplifier of FIG. 10. By supplying the external power voltage Vdd_ext to a band-gap reference circuit BGR of the reference voltage generator RVG, a band-gap reference voltage Vref of about 1.23 V is created from the band-gap reference circuit BGR. From this reference voltage Vref, the internal regulated power supply voltage V_{REF} and the internal regulated power supply voltage Vdd_int which are maintained stable to about 2.45 V are created.

In the CMOS rail-to-rail amplifier which constitutes the first voltage follower AMP1, the second voltage follower AMP2, and the third voltage follower AMP3 of the AFC-control D/A converter 315 of the mobile terminal device illustrated in FIG. 1 as one embodiment of the present invention, the external power voltage Vdd_ext is supplied to an NMOS differential input circuit NMOS_DA, a bias circuit BIAS_CKT, and a CMOS output circuit OUT_CKT, as illustrated in FIG. 10. In the CMOS rail-to-rail amplifier which constitutes at least the third voltage follower AMP3 of the AFC-control D/A converter (AFCDAC) 315, an internal regulated power supply voltage Vdd_int of about 2.45 V generated from the reference voltage generator RVG is supplied to a PMOS differential input circuit PMOS_DA, as illustrated in FIG. 10. Even in the CMOS rail-to-rail amplifier which constitutes the first voltage follower AMP1 and the second voltage follower AMP2 of the AFC-control D/A converter (AFCDAC) 315, the PMOS differential input circuit PMOS_DA is recommended to be supplied with the internal regulated power supply voltage Vdd_int of about 2.45 V generated from the reference voltage generator RVG, as illustrated in FIG. 10.

<<AFC-Control D/A Converter>>

FIG. 11 is a circuit diagram illustrating the constitution of the AFC-control D/A converter (AFCDAC) 315 arranged in the RF analog signal processing integrated circuit (RF_IC) 300 of the mobile terminal device illustrated in FIG. 1 as one embodiment of the present invention. The point that the AFC-control D/A converter (AFCDAC) 315 of FIG. 11 is different from the AFC-control D/A converter 315 illustrated in FIG. 2 is that the internal regulated power supply voltage Vdd_int maintained stable to about 2.45 V as well as the external power voltage Vdd_ext is supplied to three voltage followers AMP1, AMP2, AMP3 of the AFC-control D/A converter (AFCDAC) 315. As a result, inside the three voltage followers AMP1, AMP2, AMP3, as illustrated in FIG. 10, the external power voltage Vdd_ext is supplied to the NMOS differential input circuit NMOS_DA, the bias circuit BIAS_CKT, and the CMOS output circuit OUT_CKT, and the internal regulated power supply voltage Vdd_int of about 2.45 V generated from the reference voltage generator RVG is supplied to the PMOS differential input circuit PMOS_DA. The internal regulated power supply voltage V_{REF} of about 2.45 V generated together with the internal regulated power supply voltage Vdd_int from the reference voltage generator RVG is supplied to the top-stage resistance R of the first variable voltage divider VDIV1 of the AFC-control D/A converter (AFCDAC) 315 as a reference voltage.

In this way, in the CMOS rail-to-rail amplifier which constitutes at least the third voltage follower AMP3 of the AFC-control D/A converter (AFCDAC) 315, the internal regulated power supply voltage Vdd_int, which is generated from the reference voltage generator RVG and maintained almost stable, is supplied to the PMOS differential input circuit PMOS_DA. Therefore, even if the external power voltage Vdd_ext changes, the level of the internal regulated power supply voltage Vdd_int is suppressed to a very small change. As a result, increase of the current value of MP3 as a current source transistor of the PMOS differential input circuit PMOS_DA due to the change of the external power voltage Vdd_ext is also suppressed to a small increase. At this time, even if there is some shifting in the pair nature of the electrical property of MP1, MP2 of the PMOS differential input circuit PMOS_DA, the input offset voltage Vinoffset (P) of the PMOS differential input circuit PMOS_DA does not increase, and finally, the change ΔVout of the AFC control analog output signal (V_{TUNE}) of the AFC-control D/A converter (AFCDAC) 315 can be reduced.

<<Simulation Result>>

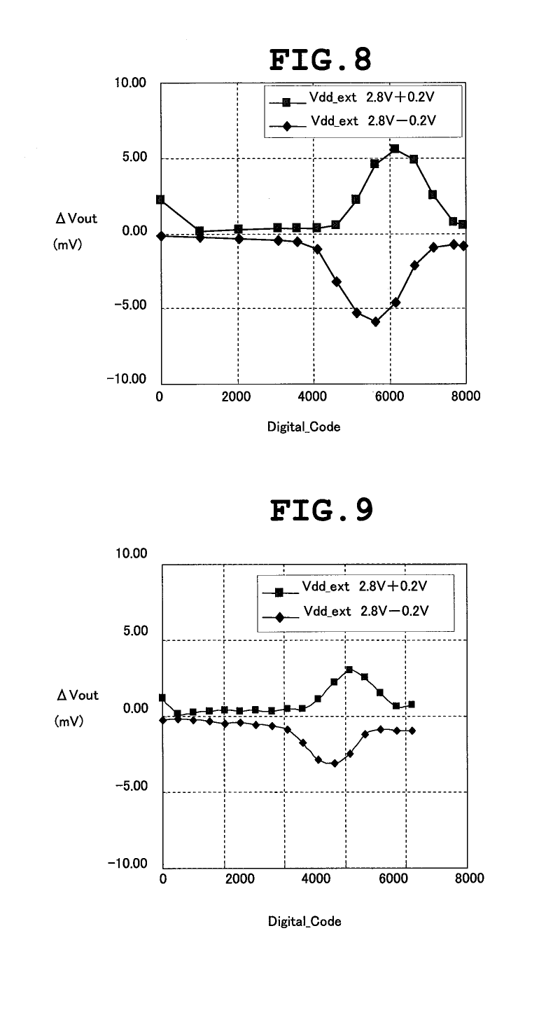

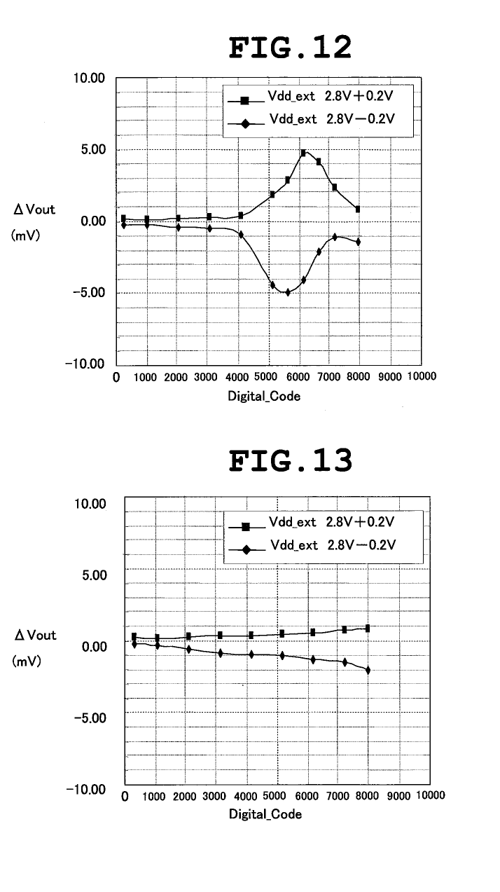

FIG. 12 is a drawing of the simulation result illustrating change ΔVout of the AFC control analog output signal (V_{TUNE}) of the AFC-control D/A converter (AFCDAC) 315 illustrated in FIG. 11, when the source of MP3, as a current source transistor of the PMOS differential input circuit PMOS_DA of the CMOS rail-to-rail amplifier illustrated in FIG. 10, is connected to the external power voltage Vdd_ext as usual, instead of the internal regulated power supply voltage Vdd_int. In this case, the change ΔVout of the AFC control analog output signal (V_{TUNE}) of the AFC-control D/A converter (AFCDAC) 315 becomes as a large level of about from −5.0 mV to +5.0 mV, almost same as in FIG. 8.

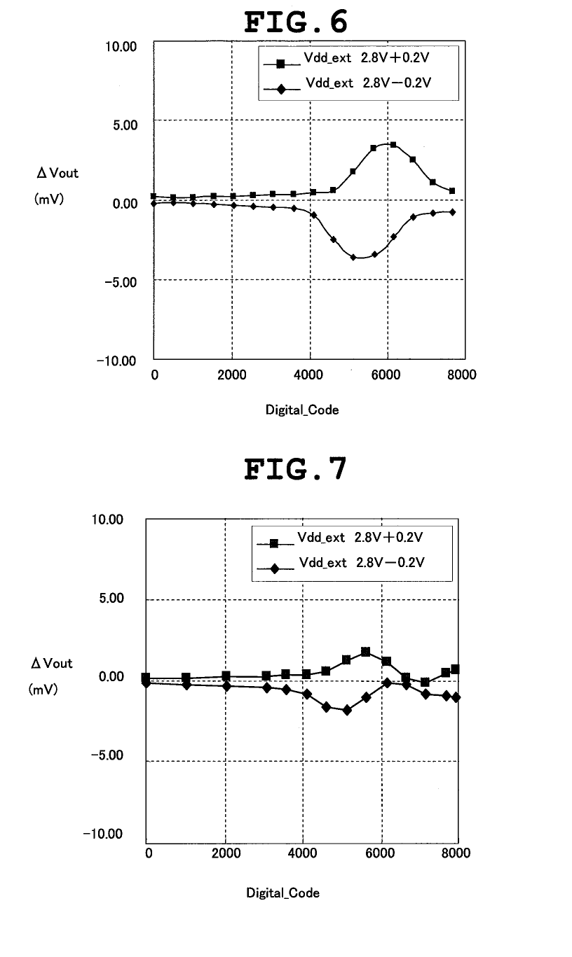

FIG. 13 is a drawing of the simulation result illustrating change ΔVout of the AFC control analog output signal (V_{TUNE}) of the AFC-control D/A converter 315 illustrated in FIG. 11, when the source of MP3, as a current source transistor of the PMOS differential input circuit PMOS_DA of the CMOS rail-to-rail amplifier illustrated in FIG. 10, is connected to the internal regulated power supply voltage Vdd_int according to the embodiment of the present invention, instead of the external power voltage Vdd_ext. The change ΔVout of the AFC control analog output signal (V_{TUNE}) of the AFC-control D/A converter (AFCDAC) 315 in the case of the embodiment of the present invention is recognized to be suppressed to the almost same small level of from about −2.0 mV to +11.0 mV, when compared with the characteristics illustrated from FIG. 5 to FIG. 9, and in FIG. 12.

In addition, the change ΔVout of the AFC control analog output signal (V_{TUNE}) of the very small level of about −2.0 mV to +1.0 mV is thought to be due to the fact that the band-gap reference voltage Vref of about 1.23 V generated from the band-gap reference circuit BGR of the reference voltage generator RVG of the CMOS rail-to-rail amplifier of FIG. 10 changes to some extent due to the change of the external power voltage Vdd_ext.

<<Fractional-N PLL>>

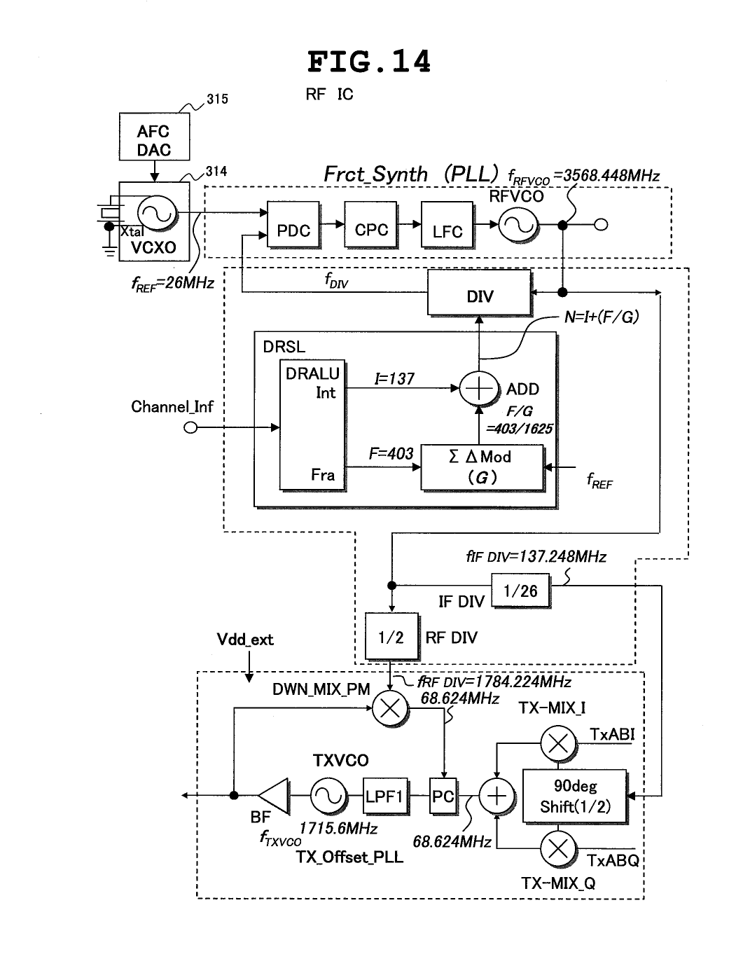

FIG. 14 is a drawing illustrating the constitution of a fractional synthesizer Frct_Synth of the fractional-N PLL arranged in the RF analog signal processing integrated circuit (RF_IC) 300 of the mobile terminal device illustrated in FIG. 1 as one embodiment of the present invention.

As illustrated in FIG. 14, the fractional synthesizer Frct_Synth includes the reference frequency oscillator (VCXO) 314 which is set so as to generate a stable-and-accurate reference oscillating frequency f_{REF} by the crystal oscillator Xtal and the AFC control analog output signal (V_{TUNE}) of the AFC-control D/A converter (AFCDAC) 315. The reference oscillating frequency f_{REF} is set, for example, as the frequency of 26 MHz. The reference frequency signal of the reference oscillating frequency f_{REF} from the reference frequency oscillator (VCXO) 314 is supplied to one input terminal of a phase comparator PDC of the fractional PLL circuit. The output of the phase comparator PDC is supplied to an RF voltage controlled oscillator RFVCO via a charge pump circuit CPC and a low pass filter LFC. The output of the RF voltage controlled oscillator RFVCO is supplied to the input of a divider DIV. The dividing output signal of the divider DIV is supplied to another input terminal of the phase comparator PDC. The control input terminal of the divider DIV, which controls the dividing ratio, is connected to a division ratio setting logic DRSL. Channel selection information Channel_inf for RF communication from the baseband LSI (not shown) is supplied to the division ratio setting logic DRSL. The divider DIV is constructed by a counter. The divider DIV counts up, from zero for example, the change from a low level to a high level of the output of the RF voltage controlled oscillator RFVCO, and changes the dividing output signal of the divider DIV from a low level to a high level, at the frequency of a certain value minus one, the certain value being set at the control input terminal to control a dividing ratio. When the dividing output signal of the divider DIV becomes the high level, the count value of the counter is set to zero by the next change from the low level to the high level of the output of the RF voltage controlled oscillator RFVCO, the dividing output signal of divider DIV is returned to the low level, and the following dividing operation is performed. The division ratio setting logic DRSL is comprised of a division ratio arithmetic unit DRALU, a ΣΔ-modulator ΔΣMod, and an adder ADD. First, an integer unit Int and a fraction unit Fra of the division ratio arithmetic unit DRALU calculate the integral value information I and the fraction information F based on the inputted channel selection information Channel_inf. The integral value information I from the integer unit Int of the division ratio arithmetic unit DRALU is supplied to one input terminal of the adder ADD, the fraction information F from the fraction unit Fra of the division ratio arithmetic unit DRALU is supplied to the ΣΔ-modulator ΣΔMod. The reference frequency signal of the reference oscillating frequency f_{REF} from the reference frequency oscillator (VCXO) 314 is further supplied to the ΣΔ-modulator ΣΔMod as an operation clock signal. On the other hand, the ΣΔ-modulator ΣΔMod holds, as inside information, the denominator information G which sets up a dividing ratio. As an example, the denominator information G is set as 1625. From the fraction information F and the denominator information G, the ΣΔ-modulator ΣΔMod generates an output signal F/G which has information of the fraction information F divided by the denominator information G, a fraction of 403/1625 for example, and supplies the output signal F/G to the other input terminal of the adder ADD. From the integral value information I (I=137 as an example) and the output signal F/G, the adder ADD supplies the divider DIV with the output information of I+F/G (137+(403/1625)=137.248 for example), as an average division ratio N. As a result, the average division ratio of the divider DIV is set as the value of 137.248, containing an integer and a fraction (decimal). Therefore, the fractional synthesizer Frct_Synth generates the RF oscillation output signal of oscillating frequency f_{RFVCO} of 3568.448 MHz which is the product of the reference oscillating frequency f_{REF} (26 MHz) from the reference frequency oscillator (VCXO) 314 and the average division ratio N (137.248). If the average division ratio N is described in detail, a dividing ratio n of the divider DIV will be changed from n (=I=137) to n+1 (=I+1=138) in response to the integral value information I (I=137) from the integer unit Int of the division ratio arithmetic unit DRALU and the overflowed 1-bit output which occurs at a frequency of (403/1625) corresponding to the output signal F/G from the ΣΔ-modulator ΣΔMod. Therefore, the frequency at which the dividing ratio of the divider DIV is set to n (=I=137) is 1222/1625=75.2%, and the frequency at which the dividing ratio of divider DIV is set to n+1 (=I+1=138) is 403/1625=24.8%. Therefore, the average division ratio N is set to 137×0.752+138×0.248=137.248.

Frequency control of the transmission-system signal processing subunit of the communication integrated circuit RF IC is performed using the fractional-synthesizer Frct_Synth including the reference frequency oscillator (VCXO) 314. The closed-loop band of the fractional-N PLL circuit, which constitutes this fractional synthesizer Frct_Synth, is set as the order of several tens kHz, far lower than 100 kHz. To be specific, this closed-loop band is set as 30 kHz, for example. The transmission-system signal processing subunit includes a transmission-system offset PLL circuit TX_Offset_PLL. By supplying the RF oscillation output signal of the oscillating frequency f_{RFVCO} (3568.448 MHz), which is the output of the RF voltage controlled oscillator RFVCO of the fractional synthesizer Frct_Synth, to an intermediate frequency divider IF DIV with a dividing ratio of 26, a twofold intermediate frequency signal (137.248 MHz) is created from the output of the intermediate frequency divider IF DIV. By supplying this twofold intermediate frequency signal (137.248 MHz) to the input of a 90-degree phase shifter 90degShift, two intermediate frequency signals (68.624 MHz) which are mutually different in phase by 90 degrees are created. By supplying to transmission-mixers TX-MIX_I and TX-MIX_Q the two intermediate frequency signals (68.624 MHz) which are different in phase by 90 degrees from the baseband transmitting signals TxABI and TxABQ, the intermediate frequency transmitting signal (68.624 MHz) after vector composition is created in the output of an adder connected to the output of the transmission mixers TX-MIX_I and TX-MIX_Q. This intermediate frequency transmitting signal (68.624 MHz) is supplied to one input terminal of a phase comparator PC. By supplying the output of the phase comparator PC to an RF transmission voltage controlled oscillator TXVCO via a low pass filter LF1, the frequency of the RF transmission voltage controlled oscillator TXVCO is controlled to about 1715.6 MHz. The oscillation output signal of the RF transmission voltage controlled oscillator TXVCO is supplied to one input terminal of a phase-controlled-feedback frequency down mixer DWN_MIX_PM via a buffer amplifier BF. A down mixer RF signal (1784. 224 MHz) from an RF divider RF DIV with a dividing ratio of 2 is supplied to another input terminal of the phase-controlled-feedback frequency down mixer DWN_MIX_PM. In the phase-controlled-feedback frequency down mixer DWN_MIX_PM, mixing with the oscillation signal (about 1715.6 MHz) from the RF transmission voltage controlled oscillator TXVCO and the down mixer RF signal (1784.224 MHz) from the RF divider RF DIV is performed. Therefore, from the output of the phase-controlled-feedback frequency down mixer DWN_MIX_PM, the feedback signal or the frequency of a difference (1784.224 MHz-1715.6 MHz=68.624 MHz) is created, and supplied to another input terminal of the phase comparator PC. The transmission-system offset PLL circuit TX_Offset_PLL performs negative feedback control so that the phase and frequency of the two input signals of the phase comparator PC may be in agreement, consequently, the signal of accurate RF transmission frequency f_{TXVCO} of 1715.6 MHz can be obtained from the RF transmission voltage controlled oscillator TXVCO. One input terminal of the phase comparator PC is supplied with an intermediate frequency transmitting signal f_{IF} (68.624 MHz) which is the vector composition at the output of the adder connected to the output of the transmission-mixers TX-MIX_I and TX-MIX_Q. The other input terminal of the phase comparator PC is supplied with a difference frequency signal (f_{RFVCO}/2−f_{TXVCO}) which possesses a frequency after subtracting a frequency f_{TXVCO} of the RF transmission frequency signal of the RF transmission voltage controlled oscillator TXVCO from a dividing RF oscillating frequency f_{RFVCO}/2, which is the oscillating frequency f_{RFVCO} of the RF voltage controlled oscillator RFVCO divided by the dividing ratio of 2. By the negative feedback control of the transmission-system offset PLL circuit TX_Offset_PLL, the reference frequency supplied to one input terminal of the phase comparator PC and the negative feedback frequency supplied to the other input terminal of the phase comparator PC becomes in agreement. Therefore, the following relation holds.

f_{IF}=f_{RFVCO}/2−f_{TXVCO} (Eq. 5)

When the above equation is modified, the following equation is obtained.

$$\begin{matrix}{f}_{TXVCO} = {f}_{RFVCO} / 2 - {f}_{IF} \\ = ( 3568.448 MHz / 2 ) - 68.624 MHz \\ = 1784.224 MHz - 68.624 MHz \\ = 1715.6 MHz\end{matrix} \qquad ( Eq . 6 )$$

Therefore, the RF transmission frequency f_{TXVCO} generated from the RF transmission voltage controlled oscillator TXVCO in the transmission-system offset PLL circuit TX_Offset_PLL is set up correctly, in response to the oscillating frequency f_{RFVCO} of the RF oscillation output signal generated from the RF voltage controlled oscillator RFVCO in the fractional synthesizer Frct_Synth and in response to the intermediate frequency transmitting signal f_{IF} of the output of the adder connected to the output of the transmission mixers. This intermediate frequency transmitting signal f_{IF} is also correctly set up by the RF transmission frequency f_{TXVCO} generated from the RF transmission voltage controlled oscillator TXVCO in the transmission-system offset PLL circuit TX_Offset_PLL.

On the other hand, the RF transmission signal generated from the RF transmission voltage controlled oscillator TXVCO in the transmission-system offset PLL circuit TX_Offset_PLL is transmitted to a base station from an antenna via an RF power amplifier and an antenna switch.

In the fractional-N PLL circuit of fractional synthesizer Frct_Synth illustrated in FIG. 14, it is possible to reduce the external-power-voltage-change-induced change of the AFC control analog output signal of the AFC-control D/A converter for controlling the oscillating frequency of the reference frequency oscillator, which is very important when obtaining sufficient frequency band and a precise frequency resolution to choose a desired channel and to catch modulation. Consequently, it is possible to improve the data precision in transmission and reception in the EDGE system with a great communication data rate, and also to reduce the level of the neighboring disturbance signal outside the regular frequency spectrum of the RF transmission signal at the time of transmission.

The neighboring disturbance signal outside the regular frequency spectrum of the RF transmission signal undergoes electric power amplification by the RF power amplifier connected to the output of the transmission-system signal processing subunit of RF IC, and is eventually transmitted as a neighboring disturbance signal from the antenna of the mobile phone terminal apparatus. The leaking signal component in the neighborhood (400 kHz) of the RF transmission frequency f_{TXVCO} (1715.6 MHz), which is the output signal of RF transmission voltage controlled oscillator TXVCO, is severely prescribed to be not more than the predetermined value (−60 dBm) by the standard of GMSK (Gaussian Minimum Shift Keying).

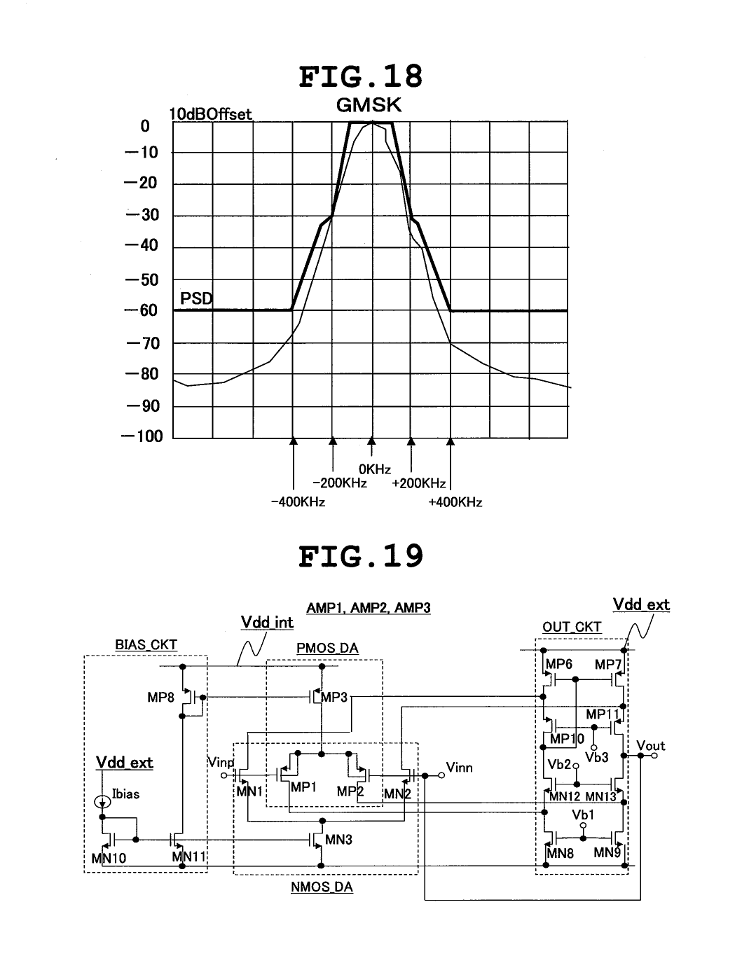

FIG. 18 is a drawing illustrating frequency spectra of an RF transmission signal of a mobile phone terminal apparatus specified by the standard of GMSK. In the figure, the thick solid line PSD is a level specified by the standard of GMSK. The amount of attenuation at ±200 kHz from the center frequency (RF transmission frequency) is specified to be less than −30 dBm, and the amount of attenuation at ±400 kHz from the center frequency (RF transmission frequency) is specified to be less than −60 dBm. The thin solid line illustrates the example which satisfies this standard. It becomes possible to satisfy the severe standard of GMSK by using the combination of the AFC-control D/A converter (AFCDAC) 315 of which the change ΔVout of the AFC control analog output signal (V_{TUNE}) illustrated in FIG. 10 is very small, and the fractional-N PLL circuit of fractional synthesizer Frct_Synth which has a sufficient frequency band and a precise frequency resolution illustrated in FIG. 14.

<<More Concrete Embodiment of the Present Invention>>

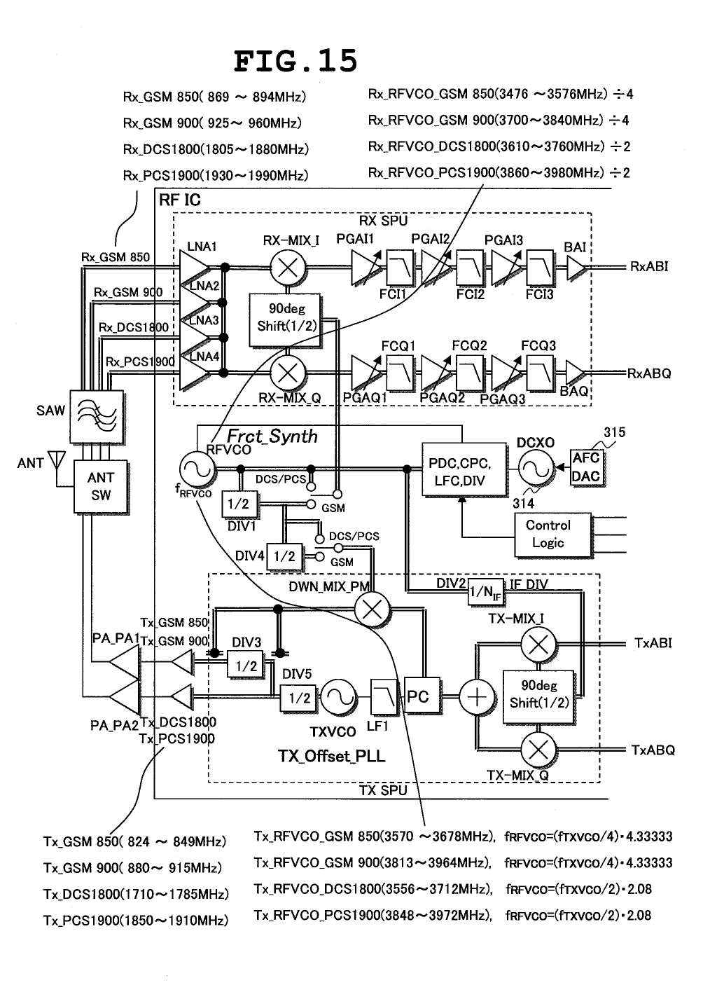

FIG. 15 is a drawing illustrating constitution of the RF analog signal processing integrated circuit RF IC according to a more concrete embodiment of the present invention. The RF IC illustrated in FIG. 15 is constituted so that it may support four bands or the quad bands of GSM 850 MHz, GSM 900 MHz, DCS 1800 MHz, and PCS 1900 MHz in both the receiving operation from a base station, and the send operation to the base station. DCS is the abbreviated name for Digital Cellular System, and PCS is the abbreviated name for Personal Communication System. In FIG. 15, Frct_Synth is an RF carrier synchronization subunit which is comprised of the fractional PLL circuit or the fractional synthesizer explained using FIG. 14.

The RF IC which supports the quad bands is comprised of the fractional synthesizer Frct_Synth explained in FIG. 14, the RF-reception-signal analog signal processing subunit RX SPU, and the RF-transmission-signal analog signal processing subunit TX SPU. An RF reception signal received with an antenna ANT of the mobile phone terminal apparatus is supplied to the RF-reception-signal analog signal processing subunit RX SPU via an antenna switch ANTSW and a surface acoustic wave filter SAW. By demodulating the inputted RF reception signal, the RF-reception-signal analog signal processing subunit RX SPU generates receiving baseband signals RxABI and RxABQ, and supplies the receiving baseband signals RxABI and RxABQ to the baseband LSI (BB_LSI). Transmitting baseband signals TxABI and TxABQ are supplied to the RF-transmission-signal analog signal processing subunit TX SPU from the baseband LSI (BB_LSI). By modulating the inputted transmitting baseband signals, the RF-transmission-signal analog signal processing subunit TXSPU creates an RF transmission signal, and supplies it to the antenna ANT of the mobile phone terminal apparatus via RF power amplifiers RF_PA1 and RD_PA2, and the antenna switch ANTSW.

First, the receiving operation of the RF-reception-signal analog signal processing subunit RX SPU is explained. The RF reception signal received with the antenna of the mobile phone terminal apparatus is supplied to four low-noise amplifiers via the antenna switch ANTSW and the surface acoustic wave filter SAW. The frequency band of the RF reception signal Rx_GSM850 of the band of GSM 850 MHz is 869 MHz-894 MHz, and is amplified by a first low-noise amplifier LNA1. The frequency band of RF reception signal Rx_GSM900 of the band of GSM 900 MHz is 925 MHz-960 MHz, and is amplified by a second low-noise amplifier LNA2. The frequency band of RF reception signal Rx_DCS1800 of the band of DCS 1800 MHz is 1805 MHz-1880 MHz, and is amplified by a third low-noise amplifier LNA3. The frequency band of RF reception signal Rx_PCS1900 of the band of PCS 1900 MHz is 1930 MHz-1990 MHz, and is amplified by a fourth low-noise amplifier LNA4. The RF-amplified reception output signal of the four low-noise amplifiers LNA1-LNA4 is supplied to one input terminal of two mixing circuits RX-MIX_I and RX-MIX_Q which serve as a receive mixer. Two RF carrier signals which are created by a 90-degree phase shifter 90degShift (½) and have about 90-degree phases are supplied to another input terminal of the two mixing circuits RX-MIX_I and RX-MIX_Q. In the receive mode of GSM 850 MHz or GSM 900 MHz, the output of an RF voltage controlled oscillator RFVCO is supplied to the 90-degree phase shifter 90degShift (½) via a ½ divider DIV1 with a dividing ratio of 2. In the receive mode of DCS 1800 MHz or PCS 1900 MHz, the output of the RF voltage controlled oscillator RFVCO is directly supplied to the 90-degree phase shifter 90degShift (½). From the output of the mixing circuit RX-MIX_I, and the output of the mixing circuit RX-MIX_Q, a receiving baseband signal RxABI and a receiving baseband signal RxABQ are generated, respectively. The receiving baseband signal RxABI and the receiving baseband signal RxABQ are supplied to the baseband LSI (BB_LSI) via variable gain amplifiers PGAI1, PGAI2, PGAI3, filter circuits FCI1, FCI2, FCI3 and a buffer amplifier BAI, and via variable gain amplifiers PGAQ1, PGAQ2, PGAQ3, filter circuits FCQ1, FCQ2, FCQ3 and a buffer amplifier BAQ, respectively.

In order to support the receiving operation in 869 MHz-894 MHz of the frequency band of the RF reception signal Rx_GSM850 of the band of GSM 850 MHz, the oscillating frequency f_{RFVCO} of the RF voltage controlled oscillator RFVCO is set as 3476 MHz-3576 MHz. The oscillating frequency f_{RFVCO} of this RF voltage controlled oscillator RFVCO undergoes (¼)-dividing by the divider DIV1 (½) with the dividing ratio set as 2 and the 90-degree phase shifter 90degShift (½). The RF divided frequency signal of 869 MHz-894 MHz after the (¼)-dividing is supplied to the two mixing circuits RX-MIX_I and RX-MIX_Q which constitute a receive mixer. Thereby, analog baseband reception signals RxABI and RxABQ after the reception of the RF reception signal Rx_GSM850 of the band of GSM 850 MHz are created from the output of two mixing circuits RX-MIX_I and RX-MIX_Q. In order to support the receiving operation in 925 MHz-960 MHz of the frequency band of RF reception signal Rx_GSM900 of the band of GSM 900 MHz, the oscillating frequency f_{RFVCO} of the RF voltage controlled oscillator RFVCO is set as 3700 MHz-3840 MHz. The oscillating frequency f_{RFVCO} of this RF voltage controlled oscillator RFVCO undergoes (¼)-dividing by the divider DIV1 (½) with the dividing ratio set as 2 and the 90-degree phase shifter 90degShift (½). The RF divided frequency signal of 925 MHz-960 MHz after the (¼)-dividing is supplied to the two mixing circuits RX-MIX_I and RX-MIX_Q which constitute the receive mixer. Thereby, analog baseband reception signals RxABI and RxABQ after the reception of the RF reception signal Rx_GSM900 of the band of GSM 900 MHz are created from the output of two mixing circuits RX-MIX_I and RX-MIX_Q. In order to support the receiving operation in 1805 MHz-1880 MHz of the frequency band of RF reception signal Rx_DCS1800 of the band of DCS 1800 MHz, the oscillating frequency f_{RFVCO} of the RF voltage controlled oscillator RFVCO is set as 3610 MHz-3760 MHz. The oscillating frequency f_{RFVCO} of this RF voltage controlled oscillator RFVCO undergoes (½)-dividing by the 90-degree phase shifter 90degShift (½). The RF divided frequency signal of 1805 MHz-1880 MHz after the (½)-dividing is supplied to the two mixing circuits RX-MIX_I and RX-MIX_Q which constitute the receive mixer. Thereby, analog baseband reception signals RxABI and RxABQ after the reception of the RF reception signal Rx_DCS1800 of the band of DCS 1800 MHz are created from the output of two mixing circuits RX-MIX_I and RX-MIX_Q. In order to support the receiving operation in 1930 MHz-1990 MHz of the frequency band of RF reception signal Rx_PCS1900 of the band of PCS 1900 MHz, the oscillating frequency f_{RFVCO} of the RF voltage controlled oscillator RFVCO is set as 3860 MHz-3980 MHz. The oscillating frequency f_{RFVCO} of this RF voltage controlled oscillator RFVCO undergoes (½)-dividing by the 90-degree phase shifter 90degShift (½). The RF divided frequency signal of 1930 MHz-1990 MHz after the (½)-dividing is supplied to two mixing circuits RX-MIX_I and RX-MIX_Q which constitute the receive mixer. Thereby, analog baseband reception signal RxABI and RxABQ after the reception of the RF reception signal Rx_PCS1900 of the band of PCS 1900 MHz are created from the output of two mixing circuits RX-MIX_I and RX-MIX_Q.

Next, the send operation of the RF-transmission-signal analog signal processing subunit TX SPU is explained. By supplying the RF oscillation output signal of the output of the RF voltage controlled oscillator RFVCO of the fractional synthesizer Frct_Synth to an intermediate frequency divider DIV2 (1/N_{IF}) with the predetermined dividing ratio, a twofold intermediate frequency signal is created from the output of the intermediate frequency divider DIV2 (1/N_{IF}). By supplying this twofold intermediate frequency signal to the input of a 90-degree phase shifter 90degShift, two intermediate frequency signals of 68.624 MHz with different phases by about 90 degrees are created. By supplying the transmission mixers TX-MIX_I and TX-MIX_Q with the baseband transmitting signals TxABI and TxABQ from the baseband LSI (BB_LSI) and the two intermediate frequency signals of 68.624 MHz with different phases by about 90 degrees, the 68.624-MHz intermediate frequency transmitting signal after vector composition is created at the output of the adder connected to the output of the transmission mixers TX-MIX_I and TX-MIX_Q. This 68.624 MHz intermediate frequency transmitting signal is supplied to one input terminal of the phase comparator PC. By supplying the output of the phase comparator PC to the RF-transmission voltage controlled oscillator TXVCO via the low pass filter LPF1, the oscillating frequency of the RF-transmission voltage controlled oscillator TXVCO is controlled to about 3431.2 MHz. The frequency bands of the RF transmission signal Tx_GSM850 of the band of GSM 850 MHz are 824 MHz-849 MHz. The oscillation output signals of 3296 MHz-3396 MHz of the RF-transmission voltage controlled oscillator TXVCO are supplied to the input of the first RF power amplifier RF_PA1 via two dividers DIV5 (½) and DIV3 (½), each with the dividing ratio of 2. The frequency bands of the RF transmission signal Tx_GSM900 of the band of GSM 900 MHz are 880 MHz-915 MHz. The oscillation output signals of 3520 MHz-3660 MHz of the RF-transmission voltage controlled oscillator TXVCO are supplied to the input of the first RF power amplifier RF_PA1 via two dividers DIV5 (½) and DIV3 (½), each with the dividing ratio of 2. The frequency bands of the RF transmission signal Tx_DCS1800 of the band of DCS 1800 MHz are 1710 MHz-1785 MHz. The oscillation output signals of 3420 MHz-3570 MHz of the RF-transmission voltage controlled oscillator TXVCO are supplied to the input of the second RF power amplifier RF_PA2 via one divider DIV5 (½) with the dividing ratio of 2. The frequency bands of the RF transmission signal Tx_PCS1900 of the band of PCS 1900 MHz are 1850 MHz-1910 MHz. The oscillation output signals of 3700 MHz-3820 MHz of the RF-transmission voltage controlled oscillator TXVCO are supplied to the input of the second RF power amplifier RF PA2 via one divider DIV5 (½) with the dividing ratio of 2.

It is necessary to support the send operation with the frequency band 824 MHz-848 MHz of the RF transmission signal Tx_GSM850 of the band of GSM 850 MHZ and the frequency band 880 MHZ-915 MHz of the RF transmission signal Tx_GSM900 of the band of GSM 900 MHz. Therefore, the oscillating frequency f_{RFVCO} Of the RF voltage controlled oscillator RFVCO is supplied to one input terminal of the phase-controlled-feedback frequency down mixer DWN_MIX_PM of the transmission-system offset PLL circuit TX_Offset_PLL via two dividers DIV1 (½) and DIV4 (½), each with the dividing ratio of 2. Dividing ratio N_{IF} is set as 26 for the intermediate frequency divider DIV2 (1/N_{IF}) which is connected to the 90-degree phase shifter 90degShift (½) connected to two mixing circuits TX-MIX_I and TX-MIX_Q constituting the transmission mixer of the transmission-system offset PLL circuit TX_Offset PLL. Therefore, the oscillation output signal of the oscillating frequency f_{TXVCO} of the RF transmission voltage controlled oscillator TXVCO is supplied to one input terminal of the phase-controlled-feedback frequency down mixer DWN_MIX_PM, via two dividers DIV5 (½) and DIV3 (½), each with the dividing ratio of 2. A (¼)-dividing signal of the oscillating frequency f_{RFVCO} Of the RF voltage controlled oscillator RFVCO is supplied to the other input terminal of the phase-controlled-feedback frequency down mixer DWN_MIX_PM via two dividers DIV1 (½) and DIV4 (½). In the phase-controlled-feedback frequency down mixer DWN_MIX_PM, mixing with a (¼)-dividing signal of the oscillating frequency f_{RFVCO} and a (¼)-dividing signal of the oscillation output signal of the oscillating frequency f_{TXVCO} of the RF transmission voltage controlled oscillator TXVCO is performed. Therefore, from the output of the phase-controlled-feedback frequency down mixer DWN_MIX_PM, the feedback signal of the frequency of difference of ((¼)×f_{RFVCO}−(¼)×f_{TXVCO}) is created, and supplied to the other input terminal of the phase comparator PC of the transmission-system offset PLL circuit TX_Offset_PLL. One input terminal of the phase comparator PC is supplied with an intermediate frequency transmitting signal f_{IF} after vector composition of the output of the adder connected to the output of the transmission mixers TX-MIX_I and TX-MIX_Q. This intermediate frequency transmitting signal f_{IF} is set to f_{RFVCO}/52 by the dividing ratios N_{IF} of 26 of the intermediate frequency divider DIV2 (1/N_{IF}) and the (½)-dividing function in the 90-degree phase shifter 90degShift. The reference frequency of one input terminal of the phase comparator PC and the negative feedback frequency of the other input terminal of the phase comparator PC becomes in agreement by the negative feedback control of the transmission-system offset PLL circuit TX_Offset_PLL. Accordingly, the following relation holds.

$$\begin{matrix}{f}_{RFVCO} / 52 = ( 1 / 4 ) \times {f}_{RFVCO} - ( 1 / 4 ) \times {f}_{TXVCO} ( 1 / 4 ) \times {f}_{TXVCO} \\ = ( 1 / 4 ) \times {f}_{RFVCO} - {f}_{RFVCO} / 52 \\ = ( ( 13 - 1 ) / 52 ) \times {f}_{RFVCO} \\ = ( 12 / 52 ) \times {f}_{RFVCO}\end{matrix} \\ ∴ {f}_{RFVCO} = 4.33333 \times ( 1 / 4 ) \times {f}_{TXVCO}$$

Therefore, it is necessary to support the send operation with the frequency band 824 MHz-848 MHz of the RF transmission signal Tx_GSM850 of the band of GSM 850 MHz, and the frequency band 880 MHz-915 MHz of the RF transmission signal Tx_GSM900 of the band of GSM 900 MHz. For this purpose, it is just good to set up the oscillating frequency f_{RFVCO} of the RF voltage controlled oscillator RFVCO as 4.33333 times the (¼)-dividing signal ((¼)×f_{TXVCO}) of the oscillating frequency f_{TXVCO} of the RF transmission voltage controlled oscillator TXVCO. Therefore, it is just good to set the oscillating frequency f_{RFVCO} of the RF voltage controlled oscillator RFVCO as 3570.6639 MHz-3678.9971 MHz corresponding to the frequency band 824 MHz-849 MHz of the RF transmission signal Tx_GSM850 of the band of GSM 850 MHz. It is just good to set the oscillating frequency f_{RFVCO} of the RF voltage controlled oscillator RFVCO as 3813.3304 MHz-3974.997 MHz corresponding to the frequency band 880 MHz-915 MHz of the RF transmission signal Tx_GSM900 of the band of GSM 900 MHz.

It is necessary to support the send operation with the frequency band 1710 MHz-1785 MHz of the RF transmission signal Tx_DCS1800 of the band of DCS 1800 MHz and the frequency band 1850 MHz-1910 MHz of the RF transmission signal Tx_PCS1900 of the band of PCS 1900 MHz. Therefore, the oscillating frequency f_{RFVCO} of the RF voltage controlled oscillator RFVCO is supplied to one input terminal of the phase-controlled-feedback frequency down mixer DWN_MIX_PM of the transmission-system offset PLL circuit TX_Offset_PLL, via one divider DIV1 (½) with the dividing ratio of 2. Dividing ratio N_{IF} is set as 26 for the intermediate frequency divider DIV2 (1/N_{IF}) which is connected to the 90-degree phase shifter 90degShift (½) connected to two mixing circuits TX-MIX_I and TX-MIX_Q constituting the transmission mixer of the transmission-system offset PLL circuit TX_Offset_PLL. Therefore, the oscillation output signal of the oscillating frequency f_{TXVCO} of the RF-transmission voltage controlled oscillator TXVCO is supplied to one input terminal of the phase-controlled-feedback frequency down mixer DWN_MIX_PM via one divider DIV5 (½) with the dividing ratio of 2. A (½)-dividing signal of the oscillating frequency f_{RFVCO} of the RF voltage controlled oscillator RFVCO is supplied to the other input terminal of the phase-controlled-feedback frequency down mixer DWN_MIX_PM via one divider DIV1 (½). In the phase-controlled-feedback frequency down mixer DWN_MIX_PM, mixing with a (½)-dividing signal of the oscillating frequency f_{RFVCO} and a (½)-dividing signal of the oscillation output signal of the oscillating frequency f_{TXVCO} of the RF transmission voltage controlled oscillator TXVCO is performed. Therefore, from the output of the phase-controlled-feedback frequency down mixer DWN_MIX_PM, the feedback signal of the frequency of difference of ((½)×f_{RFVCO}−(½)×f_{TXVCO}) is created and supplied to the other input terminal of the phase comparator PC of the transmission-system offset PLL circuit TX_Offset_PLL. One input terminal of the phase comparator PC is supplied with the intermediate frequency transmitting signal f_{IF} after vector composition of the output of the adder connected to the output of the transmission mixer TX-MIX_I and TX-MIX_Q. This intermediate frequency transmitting signal f_{IF} is set to f_{RFVCO}/52 by the dividing ratio N_{IF} of 26 of the intermediate frequency divider DIV2 (1/N_{IF}) and the (½)-dividing function in the 90-degree phase shifter 90degShift. The reference frequency of one input terminal of the phase comparator PC and the negative feedback frequency of the other input terminal of the phase comparator PC become in agreement by the negative feedback control of the transmission-system offset PLL circuit TX_Offset_PLL. Accordingly, the following relation holds.

$$\begin{matrix}{f}_{RFVCO} / 52 = ( 1 / 2 ) \times {f}_{RFVCO} - ( 1 / 2 ) \times {f}_{TXVCO} ( 1 / 2 ) \times {f}_{TXVCO} \\ = ( 1 / 2 ) \times {f}_{RFVCO} - {f}_{RFVCO} / 52 \\ = ( ( 26 - 1 ) / 52 ) \times {f}_{RFVCO} \\ = ( 25 / 52 ) \times {f}_{RFVCO}\end{matrix} \\ ∴ {f}_{RFVCO} = 2.08 \times ( 1 / 2 ) \times {f}_{TXVCO}$$

Therefore, it is necessary to support the send operation with the frequency band 1710 MHz-1785 MHz of the RF transmission signal Tx_DCS1800 of the band of DCS 1800 MHz, and the frequency band 1850 MHz-1910 MHz of the RF transmission signal Tx_PCS1900 of the band of PCS 1900 MHz. Therefore, it is just good to set up the oscillating frequency f_{RFVCO} of the RF voltage controlled oscillator RFVCO to 2.08 times the (½)-dividing signal ((½)×f_{TXVCO}) of the oscillating frequency f_{TXVCO} of the RF transmission voltage controlled oscillator TXVCO. Therefore, it is just good to set the oscillating frequency f_{RFVCO} of the RF voltage controlled oscillator RFVCO as 3556.8 MHz-3712.8 MHz corresponding to the frequency band 1710 MHz-1785 MHz of the RF transmission signal Tx_DCS1800 of the band of DCS 1800 MHz. It is just good to set the oscillating frequency f_{RFVCO} of the RF voltage controlled oscillator RFVCO as 3848 MHz-3972.8 MHz corresponding to the frequency band 1850 MHz-1910 MHz of the RF transmission signal Tx_PCS1900 of the band of PCS 1900 MHz.

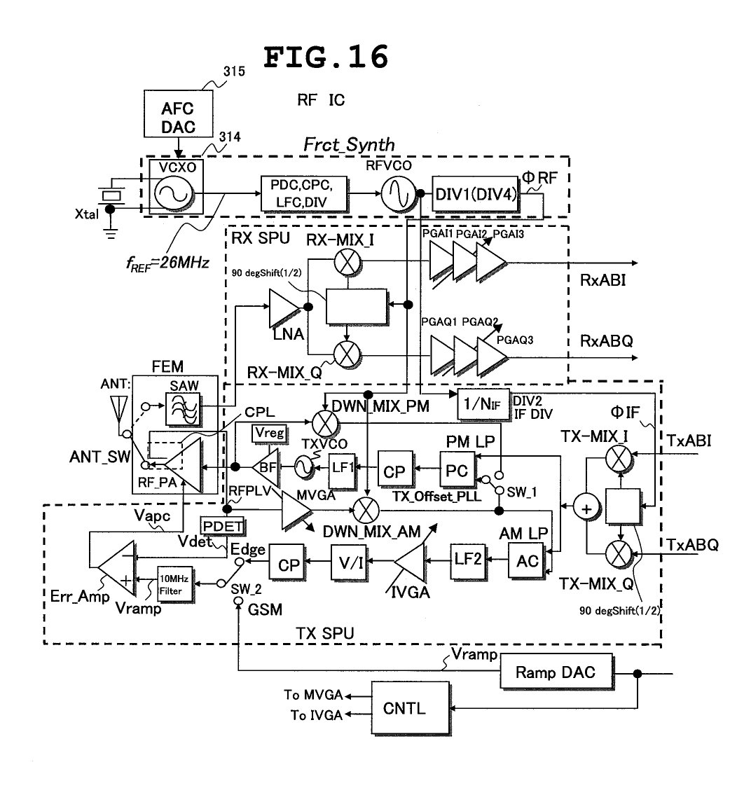

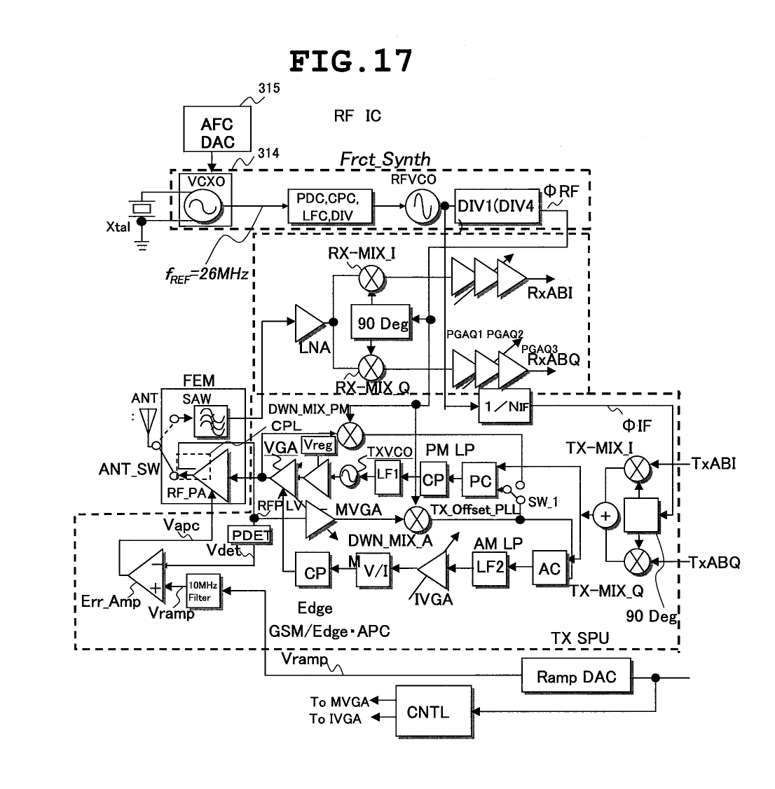

FIG. 16 is a drawing illustrating constitution of the RF analog signal processing integrated circuit RF IC according to still more concrete embodiment of the present invention.

This RF IC adopts the transmission system of the polar loop system for supporting the EDGE system which uses amplitude modulation as well as phase modulation in communication between a base station and a communication terminal apparatus.

One semiconductor chip of RF IC contains three subunits Frct_Synth, RX SPU, and TX SPU. In FIG. 16, besides the RF IC, an antenna ANT for transmission and reception and a front-end module FEM of the mobile phone terminal apparatus are also illustrated. The front-end module FEM includes an antenna switch ANT_SW, a transmission RF power amplifier RF_PA, and a power coupler CPL for detecting the transmission power from the transmission RF power amplifier RF_PA.

In FIG. 16, Frct_Synth is an RF carrier synchronization subunit which is comprised of the fractional PLL circuit or the fractional synthesizer explained using FIG. 14. In the RF carrier synchronization subunit Frct_Synth, the fractional frequency synthesizer is supplied with a system reference clock signal from a system reference clock oscillator VCXO of which the oscillating frequency f_{REF} is stably maintained with a crystal oscillator Xtal arranged outside the integrated circuit RF IC, thereby, the fractional frequency synthesizer can also maintain the RF oscillating frequency f_{RFVCO} of the RF oscillator RFVCO stably. By supplying the RF output of the RF oscillator RFVCO to a divider DIV1 (DIV4) (½ or ¼), an RF signal ΦRF is obtained from the output of the divider DIV1 (DIV4) (½ or ¼). This RF signal ΦRF is supplied to the RF-reception-signal analog signal processing subunit RX SPU and the RF-transmission-signal analog signal processing subunit TX SPU in the analog signal processing integrated circuit for RF communication RF IC. That is, the RF-transmission-signal analog signal processing subunit 302 TX SPU is constituted by the polar loop system for supporting the EDGE system.

In the time slot set as the receive state, the antenna switch ANT_SW of the front-end module FEM is connected to the upper side. Therefore, the RF reception signal received with the antenna ANT is supplied to the input of the low-noise amplifier LNA of the RF-reception-signal analog signal processing subunit RX SPU via the receive filter SAW which is comprised of the surface acoustic wave device, for example. The RF-amplified output of the low-noise amplifier LNA is supplied to one input of two mixing circuits RX-MIX_I and RX-MIX_Q which constitute a receive mixer. The other input of the two mixing circuits RX-MIX_I and RX-MIX_Q is supplied with two RF carrier signals which have a phase of 90 degrees and is created by a 90-degree phase shifter 90degShift (½) based on the RF signal ΦRF from the divider DIV1 (DIV4) (½ or ¼). Consequently, in the mixing circuits RX-MIX_I and RX-MIX_Q of the receive mixer, the direct frequency down-conversion from the RF reception signal frequency to a baseband signal frequency is performed, and received analog baseband signals RxABI and RxABQ are obtained from the output thereof. After the received analog baseband signals RxABI and RxABQ are amplified by variable gain amplifiers PGAI1, PGAI2, PGAI3, PGAQ1, PGAQ2, and PGAQ3, of which gain is adjusted by the receive time-slot setup, then the received analog baseband signals RxABI and RxABQ are converted into a digital signal by an A/D converter in the chip of RF IC. The digital reception signal is supplied to a baseband signal processing LSI (not shown).

In the time slot set as the send state, a digital transmission baseband signal is supplied to RF IC from a baseband signal processing LSI (not shown). Consequently, from the output of a D/A converter (not shown) in RF IC, an analog baseband transmitting signals TxABI and TxABQ are supplied to one input of two mixing circuits TX-MIX_I and TX-MIX_Q of the transmission mixer of the RF-transmission-signal analog signal processing subunit TX SPU. A signal ΦIF of the intermediate frequency f_{IF} is obtained by dividing an RF oscillating frequency f_{RFVCO} Of the RF oscillator RFVCO by an intermediate frequency divider DIV2 (1/N_{IF}). Two IF transmission carrier signals which have the 90-degree phase and are created by a 90-degree phase shifter 90degShift based on the IF signal ΦIF are supplied to the other input of the two mixing circuits TX-MIX_I and TX-MIX_Q. Consequently, in the mixing circuits TX-MIX_I and TX-MIX_Q of the transmission mixer, the frequency up-conversion from the frequency of the analog baseband transmitting signal to the IF transmitting signal is performed, and one IF transmitting modulation signal after vector composition is obtained from an adder. The IF transmitting modulation signal from the adder is supplied to one input of a phase comparator PC which constitutes a PM loop circuit PM LP for transmission of the phase modulation component in the RF-transmission-signal analog signal processing subunit TX SPU. In the PM loop circuit PM LP, the output of the phase comparator PC is transmitted to the control input of a transmission voltage controlled oscillator TXVCO via a charge pump CP and a low pass filter LF1.

The operating voltage from a voltage regulator Vreg is supplied to a buffer amplifier BF of which the input is connected to the output of the transmission voltage controlled oscillator TXVCO. The output of the transmission voltage controlled oscillator TXVCO is supplied to the input of a frequency down mixer DWN_MIX_PM for the PM loop to which the RF signal ΦRF is also supplied from the divider DIV1 (DIV4) (½ or ¼). Thereby, a first IF transmission feedback signal is obtained from the output of DWN_MIX_PM. As the phase modulation information in the case where the transmission time slot is the GSM system, this first IF transmission feedback signal is supplied via a switch SW_1 to another input of the phase comparator PC which constitutes the PM loop circuit PM LP. As a result, the sending signal which is an output of the transmission RF power amplifier RF_PA comes to contain the accurate phase modulation information of the GSM system. Transmission power information (amplification gain of the transmission RF power amplifier RF_PA) in the case where the transmission time slot is the GSM system is specified by a ramp output voltage Vramp of a ramp-signal D/A converter Ramp DAC in RF IC. This ramp output voltage Vramp is supplied to a 10 MHz filter (10 MHz Filter) via a switch SW2. The ramp output voltage Vramp from the filter and a transmission power detecting signal Vdet from the power coupler CPL and a power detection circuit PDET, which detect the transmission power of the transmission RF power amplifier RF_PA, are supplied to an error amplifier Err_Amp. The amplification gain of the transmission RF power amplifier RF_PA is set up, in proportion to the distance between the base station and the portable communication terminal, by the power supply voltage control or bias voltage control based on an automatic power control voltage Vapc from the output of the error amplifier Err_Amp. In addition, the digital ramp input signal supplied to the ramp-signal D/A converter Ramp DAC from a baseband signal processing unit like the baseband LSI is a transmission power level indication signal which indicates the level of transmission power, and controls the transmission power level high in proportion to the distance between the base station and the communication terminal apparatus. The ramp output voltage Vramp in an analog form is generated from the output of the ramp-signal D/A converter Ramp DAC.

When the transmission time slot is the EDGE system, on the other hand, the IF transmitting modulation signal from the adder will include not only the phase modulation information but also the amplitude modulation information. Therefore, the IF transmitting modulation signal from the adder is not only supplied to one input of the phase comparator PC which constitutes the PM loop circuit PM LP, but is supplied to one input of an amplitude comparator AC which constitutes an AM loop circuit AM LP. At this time, the other input of the phase comparator PC is not supplied with the output of the transmission voltage controlled oscillator TXVCO via the PM-loop frequency down mixer DWN_MIX_PM. Rather, the other input of the phase comparator PC will be supplied with the information related to the transmission power of the transmission RF power amplifier RF_PA (RF transmission power level RFPLV), via the power coupler CPL, a variable gain circuit MVGA, and an AM-loop frequency down mixer DWN_MIX_AM. The other input of the amplitude comparator AC which constitutes the AM loop circuit AM LP is supplied with the information related to the transmission power of the transmission RF power amplifier RF_PA (RF transmission power level RFPLV), via the power coupler CPL, the variable gain circuit MVGA, and the AM-loop frequency down mixer DWN_MIX AM. In the AM loop circuit AM LP, the output of the amplitude comparator AC is supplied to the 10 MHz filter (10 MHz Filter) via a low pass filter LF2, a variable gain circuit IVGA, a voltage/current converter V/I, a charge pump CP, and the switch WS2. As a result, the transmission power signal of the output of the transmission RF power amplifier RF_PA which amplifies the RF oscillation output signal of the transmission voltage controlled oscillator TXVCO comes to contain the accurate phase modulation information of the EDGE system first by the PM loop circuit PM LP. Furthermore, the transmission power signal of the output of the transmission RF power amplifier RF_PA comes to contain the accurate amplitude modulation information of the EDGE system by the AM loop circuit AM LP.

As the power coupler CPL which detects the transmission power of the transmission RF power amplifier RF_PA, a coupler which detects the transmission power of the RF power amplifier RF_PA electromagnetically or in terms of capacitance may be employed. As the power coupler CPL, a current-sense-type coupler is also employable in addition to the above examples. In the current-sense-type coupler, a detection DC-AC operating current, of small amplitude but proportional to the DC-AC operating current of the final stage power amplifying element of the RF power amplifier RF_PA, is flowed through a detection amplifying element.

In RF IC of FIG. 16, a control circuit CNTL generates two 8-bit control signals in response to the 10-bit digital ramp signal, so that the gain of two variable gain circuits MVGA and IVGA of the AM loop circuit AM LP, which respond to the ramp voltage Vramp of the ramp-signal D/A converter Ramp DAC, may have an opposite slop each other. That is, in response to the ramp voltage Vramp, when the gain of the variable gain circuit MVGA decreases, the gain of the variable gain circuit IVGA increases, thereby the sum of the gain of two variable gain circuits MVGA and IVGA becomes almost constant. As a result, the phase margin of the open-loop frequency characteristic of the AM loop circuit AM LP is avoided to become too small in response to the ramp voltage Vramp.

FIG. 17 is a drawing illustrating constitution of a different RF IC from the RF IC which adopts the transmission system of the polar loop system as illustrated in FIG. 16, in order to support the EDGE system which uses amplitude modulation as well as phase modulation. That is, RF IC illustrated in FIG. 17 adopts the transmission system of the polar modulator system in order to support the EDGE system in which communication with the base station uses amplitude modulation as well as phase modulation, and the RF-transmission-signal analog signal processing subunit TX SPU is constituted by the polar modulator system to support the EDGE system.

That is, an amplitude-modulation-loop control circuit AM_LP controls the amplitude of an RF transmission output signal from a transmission RF power amplifier RF_PA, based on a transmission intermediate frequency signal created by transmission modulation circuits TX_MIX_I and TX_MIX_Q. The amplitude-modulation-loop control circuit AM_LP is constituted as follows.

In the AM loop circuit AM LP, the output of an amplitude comparator AC is supplied to an amplitude-modulation variable gain amplifier VGA which is inserted between the output of a buffer amplifier BF and the input of a transmission voltage controlled oscillator TXVCO, via a Low pass filter LF2, a variable gain circuit IVGA, a voltage/current converter V/I, and a charge pump CP. One input terminal of the amplitude comparator AC of the AM loop circuit AM LP is supplied with the transmission intermediate frequency signal created by the transmission modulation circuit (TX_MIX_I, TX_MIX_Q). The other input terminal of the amplitude comparator AC is supplied with the information related to the transmission power of a transmission RF power amplifier RF_PA (RF transmission power level RFPLV) via a power coupler CPL, a variable gain circuit MVGA, and an AM-loop frequency down-mixer DWN_MIX_AM. As a result, the gain of the amplitude-modulation variable gain amplifier VGA is controlled by the output of the amplitude comparator AC, via the low pass filter LF2, the variable gain circuit IVGA, the voltage/current converter V/I, and the charge pump CP, so that the IF signal amplitude of one input terminal of the amplitude comparator AC may be in agreement with the IF signal amplitude of the other input terminal thereof, wherein the amplitude-modulation variable gain amplifier VGA is inserted between the output of the buffer amplifier BF and the input of the transmission voltage controlled oscillator TXVCO. Consequently, the transmission power of the transmission RF power amplifier RF_PA will contain the accurate amplitude modulation information of the EDGE system.

In the case of the GSM system and in the case of the EDGE system, the ramp output voltage Vramp of the ramp-signal D/A converter Ramp DAC and the transmission power detecting signal Vdet from the power coupler CPL and the power detection circuit PDET, which detect the transmission power of the transmission RF power amplifier RF_PA, are supplied to the error amplifier Err_Amp. By the power supply voltage control or the bias voltage control in terms of an automatic power control voltage Vapc from the output of the error amplifier Err_Amp, the amplification gain of the transmission RF power amplifier RF_PA is set up in proportion to the distance of a base station and a portable communication terminal. Consequently, the APC control is successfully performed.

FIG. 19 is a circuit diagram illustrating other constitution of the CMOS rail-to-rail amplifier which includes three voltage followers (AMP1, AMP2, AMP3) of AFC-control D/A converter (AFCDAC) 315 of the mobile terminal device of FIG. 1 as one embodiment of the present invention. It is mainly the constitution of a CMOS output circuit OUT_CKT that the CMOS rail-to-rail amplifier illustrated in FIG. 19 is different from the CMOS rail-to-rail amplifier illustrated in FIG. 10. In the CMOS output circuit OUT_CKT illustrated in FIG. 19, MP6 and MP7 of PMOS as the load elements of MN1 and MN2 of NMOS of an NMOS differential input circuit (NMOS_DA) are connected in series with MP10 and MP11 of other PMOS, respectively. MN8 and MN9 of NMOS as the load element of MP1 and MP2 of PMOS of a PMOS differential input circuit (PMOS_DA) are connected in series with MN12 and MN13 of other NMOS, respectively. A first bias voltage Vb1 is supplied to the gates of MN8 and MN9 of NMOS, a second bias voltage Vb2 is supplied to the gates of MN12 and MN13 of NMOS, and a third bias voltage Vb3 is supplied to the gates of MP10 and MP11 of PMOS.

Therefore, the NMOS differential pair MN1 and MN2 of the NMOS differential input circuit (NMOS_DA) pulls up the voltage of an output terminal (Vout) to the direction of the external power voltage (Vdd_ext), in response to the differential input signal of a high level mainly from near the intermediate level between a non-inverted input terminal (Vinp) and an inverted input terminal (Vinn), due to the high degree of conduction of MP7 of PMOS of the CMOS output circuit (OUT_CKT). For example, if the voltages of the inverted input terminal (Vinn) and the output terminal (Vout) are low and a comparatively-high-level analog input voltage is supplied to the non-inverted input terminal (Vinp), MN1 and MN2 will be in an ON state and an OFF state, respectively, and the voltage of the output terminal (Vout) can be pulled up to the direction of the external power voltage (Vdd_ext) due to the high degree of conduction of MP7 of PMOS of the CMOS output circuit (OUT_CKT). On the contrary, the PMOS differential pair MP1 and MP2 of the PMOS differential input circuit (PMOS_DA) pulls down the voltage of the output terminal (Vout) to the direction of the ground potential (GND), in response to the low differential input signal mainly from near the intermediate level between the non-inverted input terminal (Vinp) and the inverted input terminal (Vinn), due to the high degree of conduction of MN9 of NMOS of the CMOS output circuit (OUT_CKT). For example, if the voltages of the inverted input terminal (Vinn) and the output terminal (Vout) are high in level and the comparatively-low analog input voltage is supplied to the non-inverted input terminal (Vinp), MP1 and MP2 will be in an ON state and an OFF state, respectively, and the voltage of the output terminal (Vout) can be pulled down to the direction of the ground potential (GND) due to the high degree of conduction of MN9 of NMOS of the CMOS output circuit (OUT_CKT). When the voltage of both the inputs of the non-inverted input terminal (Vinp) and the inverted input terminal (Vinn) is near the intermediate level, the NMOS differential input circuit (NMOS_DA) and the PMOS differential input circuit (PMOS_DA) illustrated in FIG. 19 perform a voltage follower operation jointly, rendering the voltage level of the inverted input terminal (Vinn) and the output terminal (Vout) to follow the voltage level of the non-inverted input terminal (Vinp).

The invention made by the present inventors has been concretely explained based on the embodiment in the above. However, the present invention is not limited to what has been described, and it cannot be overemphasized that the present invention can change variously in the range which does not deviate from the gist.

In the above-mentioned embodiment, the baseband signal processing LSI 400 and the application processor are constituted by the individually different semiconductor chip. However, in another embodiment, the application processor may be included in the semiconductor chip of the baseband signal processing LSI 400, thereby providing an integrated one-chip.

What is claimed is:

1. A semiconductor integrated circuit for RF communications to perform bidirectional signal transfer using a digital interface and an LSI which performs at least a baseband digital signal processing, the semiconductor integrated circuit for RF communications comprising:
an RF-reception-signal analog signal processing subunit; and
an RF-transmission-signal analog signal processing subunit,
the RF-reception-signal analog signal processing subunit being operable to perform frequency down-conversion of an RF reception signal to an analog baseband reception signal, and the RF-transmission-signal analog signal processing subunit being operable to perform frequency up-conversion of an analog baseband transmitting signal to an RF transmission signal,
the semiconductor integrated circuit for RF communications further including:
a reference frequency oscillator operable to generate a reference frequency signal for generating a high frequency signal to be used in the frequency down-conversion performed in the RF-reception-signal analog signal processing subunit and in the frequency up-conversion performed in the RF-transmission-signal analog signal processing subunit; and
an AFC-control D/A converter operable to control frequency of the reference frequency signal generated by the reference frequency oscillator, by converting an AFC control digital input signal supplied from the LSI into an AFC control analog output signal,
wherein the AFC-control D/A converter includes:
a first variable voltage divider operable to generate an analog rough selection voltage in response to a higher-order bit of the AFC control digital input signal;
a first voltage follower operable to be supplied with a voltage of one side of the analog rough selection voltage;
a second voltage follower operable to be supplied with a voltage of another side of the analog rough selection voltage;
a second variable voltage divider operable to be supplied with an output voltage of the first voltage follower and an output voltage of the second voltage follower and to generate an analog fine selection voltage in response to a lower-order bit of the AFC control digital input signal; and
a third voltage follower operable to be supplied with an output voltage of the second variable voltage divider, wherein each voltage follower of the first voltage follower, the second voltage follower, and the third voltage follower included in the AFC-control D/A converter is comprised of a CMOS rail-to-rail amplifier,
wherein the CMOS rail-to-rail amplifier is comprised of an NMOS differential input circuit, a PMOS differential input circuit, a CMOS output circuit, and a bias circuit,
wherein a non-inverted input terminal of the CMOS rail-to-rail amplifier is coupled to a gate of a first NMOS in the NMOS differential input circuit and to a gate of a first PMOS in the PMOS differential input circuit, an inverted input terminal of the CMOS rail-to-rail amplifier is coupled to an output terminal and to a gate of a second NMOS in the NMOS differential input circuit and to a gate of a second PMOS in the PMOS differential input circuit, a source of the first NMOS and a source of the second NMOS in the NMOS differential input circuit are coupled to a drain of a third NMOS serving as a first current source transistor, a source of the first PMOS and a source of the second PMOS in the PMOS differential input circuit are coupled to a drain of a third PMOS serving as a second current source transistor, a current flowing through the third NMOS serving as the first current source transistor in the NMOS differential input circuit and a current flowing through the third PMOS serving as the second current source transistor in the PMOS differential input circuit are set respectively by the bias circuit,
wherein the CMOS output circuit includes: an output PMOS operable to pull up an output voltage of the output terminal in response to a first output signal from at least one of the first NMOS and the second NMOS in the NMOS differential input circuit; and an output NMOS operable to pull down an output voltage of the output terminal in response to a second output signal from at least one of the first PMOS and the second PMOS in the PMOS differential input circuit,
wherein the semiconductor integrated circuit for RF communications further includes a reference voltage generator operable to generate a roughly-stabilized internal regulated power supply voltage from a power supply voltage,
wherein the power supply voltage is supplied to the NMOS differential input circuit, the bias circuit, and the CMOS output circuit in the CMOS rail-to-rail amplifier constituting the first voltage follower, the second voltage follower, and the third voltage follower included in the AFC-control D/A converter, and
wherein the internal regulated power supply voltage generated by the reference voltage generator is supplied to the PMOS differential input circuit in the CMOS rail-to-rail amplifier constituting at least the third voltage follower included in the AFC-control D/A converter.

2. The semiconductor integrated circuit for RF communications according to claim 1, wherein the internal regulated power supply voltage generated by the reference voltage generator is supplied to the first variable voltage divider in the AFC-control D/A converter as a reference voltage.

3. The semiconductor integrated circuit for RF communications according to claim 1, further comprising:
a PLL circuit operable to serve as a frequency synthesizer by including: a phase comparator of which one input terminal is supplied with the reference frequency signal generated by the reference frequency oscillator; a charge pump circuit responsive to an output of the phase comparator; a low-pass filter responsive to an output of the charge pump circuit; an RF voltage controlled oscillator responsive to a control output voltage of the low-pass filter; and a divider coupled between an output terminal of the RF voltage controlled oscillator and another input terminal of the phase comparator; and
an RF transmission voltage controlled oscillator operable to generate an RF transmission frequency signal for an RF transmission signal in RF communications, by using an RF oscillation output signal present in the output terminal of the RF voltage controlled oscillator in the PLL circuit,
wherein the PLL circuit serving as the frequency synthesizer is a fractional PLL circuit of which average division ratio includes an integer and a fraction as a result of alteration of division ratio in the divider.

4. The semiconductor integrated circuit for RF communications according to claim 3,
wherein the PLL circuit serving as the frequency synthesizer includes an intermediate frequency divider operable to generate an intermediate frequency signal by dividing the RF oscillation output signal generated by the RF voltage controlled oscillator,
wherein the semiconductor integrated circuit for RF communications includes: a transmission mixer operable to create an intermediate frequency transmitting signal from the intermediate frequency signal generated by the intermediate frequency divider and a transmitting baseband signal; a transmission-system offset PLL circuit; and an RF divider operable to generate a dividing RF frequency signal by dividing the RF oscillation output signal generated by the RF voltage controlled oscillator,
wherein the transmission-system offset PLL circuit includes: a phase comparator circuit of which one input terminal is supplied with the intermediate frequency transmitting signal generated by the transmission mixer; the RF-transmission voltage controlled oscillator responsive to an output of the phase comparator circuit; and a phase-controlled-feedback frequency down mixer, one input terminal of the phase-controlled-feedback frequency down mixer being supplied with the RF transmission frequency signal generated by the RF-transmission voltage controlled oscillator and another input terminal of the phase-controlled-feedback frequency down mixer being supplied with the dividing RF frequency signal generated by the RF divider, and
wherein an output signal of the phase-controlled-feedback frequency down mixer is supplied to another input terminal of the phase comparator circuit.

5. The semiconductor integrated circuit for RF communications according to claim 4,
wherein the RF-reception-signal analog signal processing subunit includes: a low-noise amplifier operable to amplify an RF reception signal; and a receive mixer operable to generate a receiving baseband signal by supply of an RF-amplified reception output signal from the low-noise amplifier,
wherein the PLL circuit serving as the frequency synthesizer includes: a first divider operable to create an RF carrier signal to be supplied to the receive mixer, by dividing the RF oscillation output signal of the oscillation frequency generated by the RF voltage controlled oscillator; and a second divider operable to divide an output signal of the first divider,
wherein, when the semiconductor integrated circuit for RF communications receives the RF reception signal in one of frequency bands of GSM 850 MHz and GSM 900 MHz, a receiving baseband signal is created by the receive mixer after frequency conversion of the RF reception signal in the one of frequency bands of GSM 850 MHz and GSM 900 MHz, by transmission of a dividing output signal generated by the first divider to the receive mixer as the RF carrier signal,
wherein, when the semiconductor integrated circuit for RF communications receives the RF reception signal in one of frequency bands of DCS 1800 MHz and PCS 1900 MHz, a receiving baseband signal is created after frequency conversion of the RF reception signal in the one of frequency bands of DCS 1800 MHz and PCS 1900 MHz, by transmission of the RF oscillation output signal of the oscillation frequency generated by the RF voltage controlled oscillator to the receive mixer as the RF carrier signal,
wherein, when the semiconductor integrated circuit for RF communications creates the RF transmission frequency signal in one of frequency bands of GSM 850 MHz and GSM 900 MHz, the intermediate frequency transmitting signal is created by the transmission mixer from the intermediate frequency signal and a transmitting baseband signal, a diving output signal of the second divider is transmitted, as the dividing RF frequency signal, to the other input terminal of the phase-controlled-feedback frequency down mixer in the transmission-system offset PLL circuit by the action of the first and second dividers as the RF divider, and the intermediate frequency transmitting signal is converted in frequency to the RF transmission frequency signal in the one of frequency bands of GSM 850 MHz and GSM 900 MHz in the transmission-system offset PLL circuit, and
wherein, when the semiconductor integrated circuit for RF communications creates the RF transmission frequency signal in one of frequency bands of DCS 1800 MHz and PCS 1900 MHz, the intermediate frequency transmitting signal is created by the transmission mixer from the intermediate frequency signal and a transmitting baseband signal, a diving output signal of the first divider is transmitted, as the dividing RF frequency signal, to the other input terminal of the phase-controlled-feedback frequency down mixer in the transmission-system offset PLL circuit by the action of the first divider as the RF divider, and the intermediate frequency transmitting signal is converted in frequency to the RF transmission frequency signal in the one of frequency bands of DCS 1800 MHz and PCS 1900 MHz in the transmission-system offset PLL circuit.

6. The semiconductor integrated circuit for RF communications according to claim 4,
wherein the semiconductor integrated circuit for RF communications is constituted by a polar loop system in order to support an EDGE system,
wherein the transmission-system offset PLL circuit includes a phase loop for phase modulation in the polar loop system and an amplitude loop in the polar loop system, and
wherein the phase comparator circuit, the RF-transmission voltage controlled oscillator, and the phase-controlled-feedback frequency down mixer in the transmission-system offset PLL circuit constitute the phase loop.

7. The semiconductor integrated circuit for RF communications according to claim 4,
wherein the semiconductor integrated circuit for RF communications includes a polar modulator system in order to support an EDGE system,
wherein the transmission-system offset PLL circuit includes a phase loop for phase modulation in the polar modulator system and an amplitude loop in the polar modulator system, and
wherein the phase comparator circuit, the RF-transmission voltage controlled oscillator, and the phase-controlled-feedback frequency down mixer in the transmission-system offset PLL circuit constitute the phase loop.

8. The semiconductor integrated circuit for RF communications according to claim 4,
wherein the RF-reception-signal analog signal processing subunit includes: a low-noise amplifier operable to amplify an RF reception signal; and a receive mixer operable to generate a receiving baseband signal by supply of an RF-amplified reception output signal generated by the low-noise amplifier and a receiving carrier signal generated by the frequency synthesizer, and
wherein the RF-transmission-signal analog signal processing subunit includes a transmission mixer operable to be supplied with the transmitting baseband signal, and the RF-transmission-signal analog signal processing subunit creates an RF transmission signal by supply of a transmitting carrier signal generated by the frequency synthesizer.

9. The semiconductor integrated circuit for RF communications according to claim 4,
wherein the fractional PLL circuit includes a ΣΔ modulator for calculation of the fraction of the average division ratio.
